(19) United States
(12) Patent Application Publication
(10) Pub. No.: US 2025/0378692 A1
(43) Pub. Date: Dec. 11, 2025

(54) TECHNIQUES FOR IMPROVING IMAGE RETRIEVAL PRECISION FOR MACHINE LEARNING SYSTEMS AND APPLICATIONS

(71) Applicant: NVIDIA Corporation, Santa Clara, CA (US)

(72) Inventors: Anurag Singh, Santa Clara, CA (US); Yifang Xu, San Jose, CA (US)

(21) Appl. No.: 18/735,964

(22) Filed: Jun. 6, 2024

(51) Int. Cl. G06V 20/58; G06F 16/732; G06V 20/40

(52) U.S. Cl. CPC G06V 20/58; G06F 16/7335; G06V 20/49; G06V 2201/07; G06V 2201/10

(57) ABSTRACT

In various examples, techniques for improving image retrieval precision for machine learning systems and applications is described herein. Systems and methods described herein may segment images into various portions (e.g., patches, tiles, areas, regions, etc.) and then use data associated with the portions to perform a search. For instance, after segmenting the images into the portions, one or more models may process the images in order to generate the data for the portions, such as data representing embeddings, identifiers, locations, and/or any other information. This data may then be used to identify at least a set of images when performing a search for a query. Additionally, systems and methods described herein may perform improved searches using compositable queries and/or user feedback.

### BACKGROUND

Data mining is important for many applications, such as to generate training data for neural networks, retrieve specific data samples for human analysis, and/or to perform other tasks. Some conventional systems that perform data mining may use language models, such as vision language models, to search through a database in order to identify images that match a natural language query. While such conventional systems may identify images that match queries, these conventional systems may also include low precision based on various factors. For instance, these conventional systems may include low precision due to the language models conflating multiple visual features for a same description, the language models lacking positional awareness based on how the language models process queries, the language models lacking the ability to count objects, the language models being unable to process queries for complex objects and/or features (e.g., specific types of street signs and/or signals, etc.), and/or other factors. As such, various techniques have been developed in order to try and improve the performance of these language models when performing searches.

For instance, some conventional systems may attempt to improve the language models using additional training, such as by fine tuning these language models using custom datasets to increase the precision. Additionally, other conventional systems may further attempt to improve the language models by adding additional layers to the language models, where the language models are then again further trained with these new layers to perform better within a certain domain. As such, for both of these techniques to be performed, additional datasets may be required for performing the additional training, which may require a large amount of human resources, computing resources (e.g., processing resources, memory resources, etc.), and/or time for building the datasets and/or for performing the training. Additionally, even after performing this additional training, these conventional systems may still include low precision for specific types of queries, such as queries that attempt to describe complex objects and/or features.

### SUMMARY

Embodiments of the present disclosure relate to techniques for improving image retrieval precision for machine learning systems and applications. Systems and methods described herein may segment images (e.g., using different scales, strided offsets, etc.) into various portions (e.g., patches, tiles, areas, regions, etc.) and then use data associated with the portions to perform a search. For instance, after segmenting the images into the portions, one or more models may process the images in order to generate the data for the portions, such as data representing embeddings, identifiers, locations, and/or any other information associated with the portions. This data may then be used to identify at least a set of images when performing a search for a query. Additionally, systems and methods described herein may perform improved searches using compositable queries and/or user feedback. For instance, a query may be separated into various concepts in order to identify images and/or filtering may be used to further identify images that are most relevant to the query. Additionally, user feedback may be used to generate additional queries that better represent the search intent of one or more users, where these additional queries may then be used to perform additional searches for images and/or use the images for other types of processing, such as in generative models to generate more relevant content.

In contrast to conventional systems, the systems and methods of the present disclosure are able to generate data representing embeddings for the portions of the images and then use this data to perform searches. For instance, and as described in more detail herein, by using this data, the systems of the present disclosure may allow for complex searches, such as searches that define locations of objects represented by images and/or define locations of objects with respect to one another as represented by images. As such, the systems of the present disclosure may provide improvements over the conventional systems that conflate multiple visual features for a same description, lack positional awareness, and/or have difficulty processing queries for complex objects and/or queries without the need to perform additional training of the underlying models. Additionally, and as also described in more detail herein, the systems of the present disclosure may use user feedback to generate improved queries that are more relevant to the user's intent. As such, and in contrast to the conventional systems, the systems of the present disclosure are able to use these improved queries to increase the precision of identifying images for queries.

### BRIEF DESCRIPTION OF THE DRAWINGS

The present systems and methods for techniques for improving image retrieval precision for machine learning systems and applications and applications are described in detail below with reference to the attached drawing figures, wherein:

FIG. 1 illustrates an example data flow diagram for a process of using data associated with portions of images to perform image retrieval, in accordance with some embodiments of the present disclosure;

FIG. 2 illustrates an example of segmenting an image into portions, in accordance with some embodiments of the present disclosure;

FIG. 3 illustrates an example of generating and/or storing data associated with an image, in accordance with some embodiments of the present disclosure;

FIG. 4 illustrates an example of providing results associated with a query, in accordance with some embodiments of the present disclosure;

FIG. 5 illustrates an example of filtering results associated with a query using additional information, in accordance with some embodiments of the present disclosure;

FIG. 6 illustrates an example of providing updated results associated with a query, in accordance with some embodiments of the present disclosure;

FIG. 7A-7B illustrate an example of providing updated results associated with a query and user feedback, in accordance with some embodiments of the present disclosure;

FIG. 8 illustrates a flow diagram showing a method for performing image retrieval using image segmentation, in accordance with some embodiments of the present disclosure;

FIG. 9 illustrates a flow diagram showing a method for combining query results in order to determine one or more images associated with a scenario, in accordance with some embodiments of the present disclosure;

FIG. 10 illustrates a flow diagram showing a method for updating a search using user feedback, in accordance with some embodiments of the present disclosure;

FIG. 11A is an illustration of an example autonomous vehicle, in accordance with some embodiments of the present disclosure;

FIG. 11B is an example of camera locations and fields of view for the example autonomous vehicle of FIG. 11A, in accordance with some embodiments of the present disclosure;

FIG. 11C is a block diagram of an example system architecture for the example autonomous vehicle of FIG. 11A, in accordance with some embodiments of the present disclosure;

FIG. 11D is a system diagram for communication between cloud-based server(s) and the example autonomous vehicle of FIG. 11A, in accordance with some embodiments of the present disclosure;

FIG. 12 is a block diagram of an example computing device suitable for use in implementing some embodiments of the present disclosure;

FIG. 13 is a block diagram of an example data center suitable for use in implementing some embodiments of the present disclosure;

FIG. 14A is a block diagram of an example generative language model system suitable for use in implementing some embodiments of the present disclosure;

FIG. 14B is a block diagram of an example generative language model that includes a transformer encoder-decoder suitable for use in implementing some embodiments of the present disclosure; and

FIG. 14C is a block diagram of an example generative language model that includes a decoder-only transformer architecture suitable for use in implementing some embodiments of the present disclosure.

### DETAILED DESCRIPTION

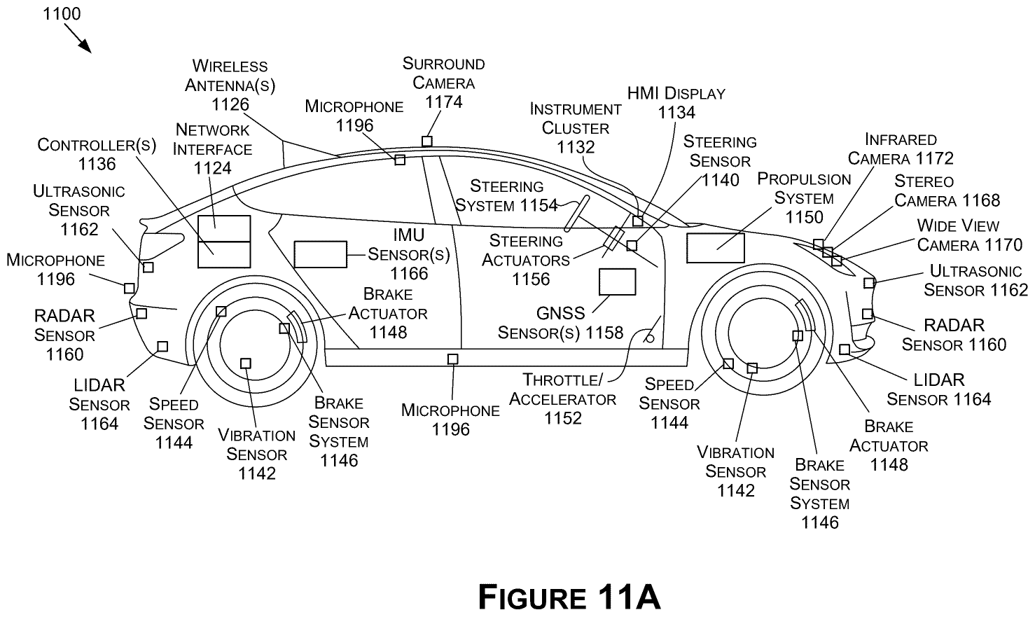

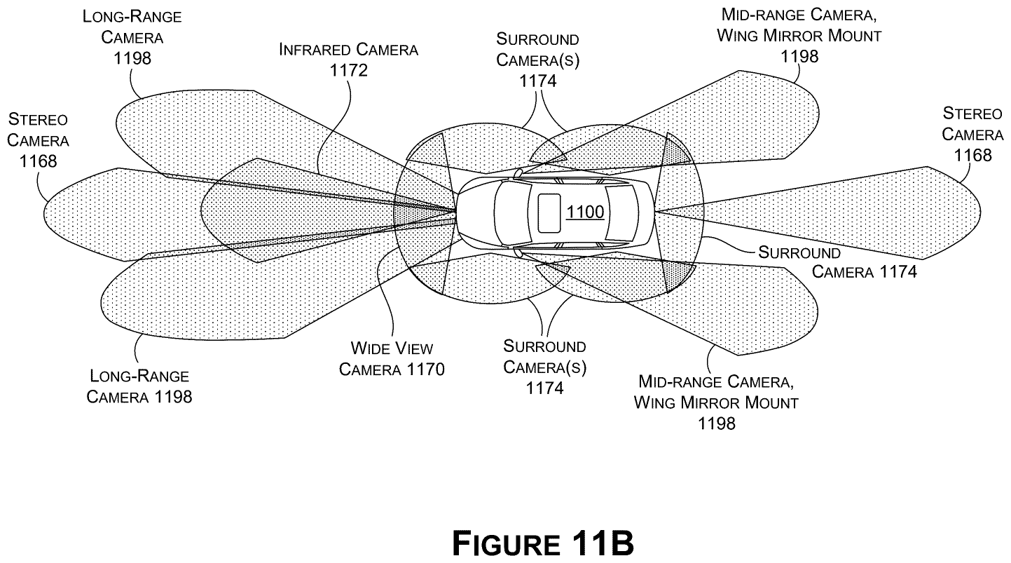

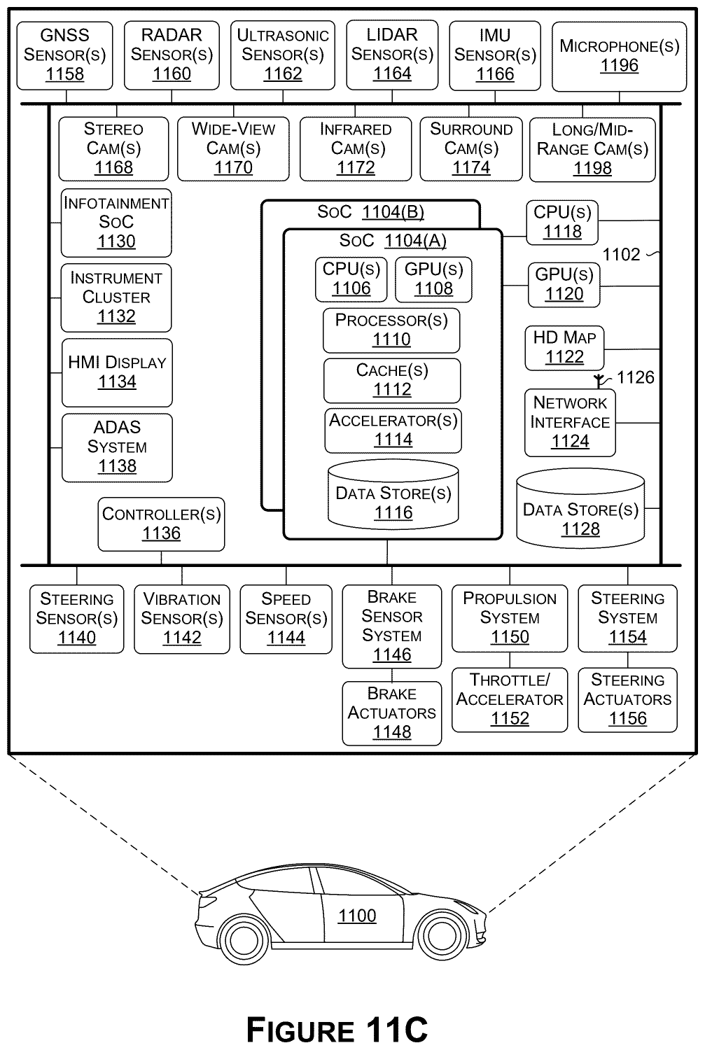

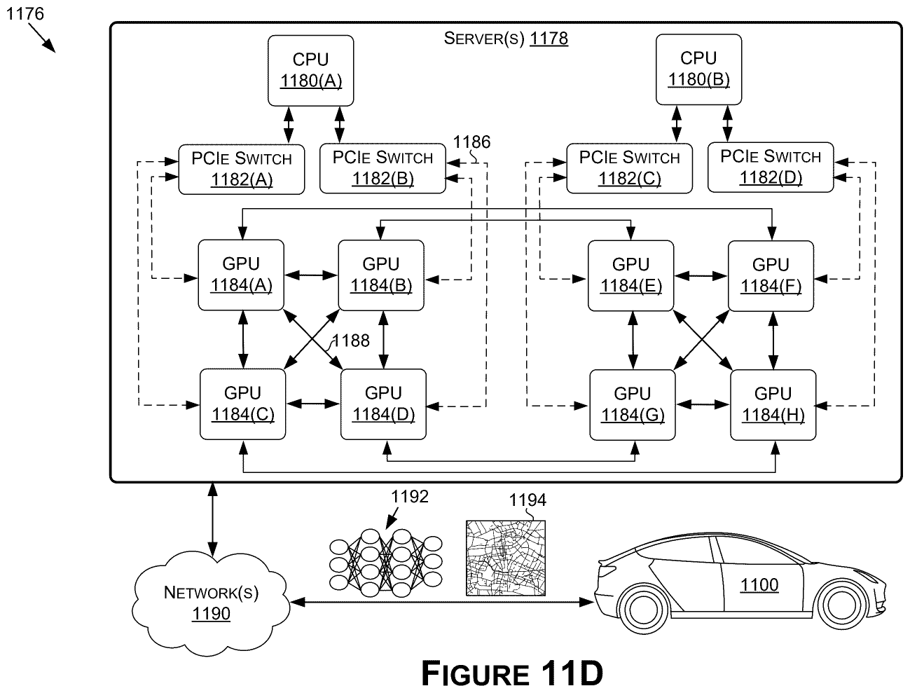

Systems and methods are disclosed related to techniques for improving image retrieval precision for machine learning systems and applications. Although the present disclosure may be described with respect to an example autonomous or semi-autonomous vehicle or machine 1100 (alternatively referred to herein as “vehicle 1100,” “ego-vehicle 1100,” “ego-machine 1100,” or “machine 1100,” an example of which is described with respect to FIGS. 11A-11D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to performing search queries for data identification in autonomous or semi-autonomous training pipelines, this is not intended to be limiting, and the systems and methods described herein may be used in augmented reality, virtual reality, mixed reality, robotics, security and surveillance, autonomous or semi-autonomous machine applications, and/or any other technology spaces where object detection and/or map creation may be used.

For instance, a system(s) may use one or more models to generate data (referred to, in some examples, as “search data”) associated with performing searches for images. As described herein, in some examples, the model(s) may include one or more language models, such as one or more vision language models, one or more multi-modal language models, one or more contrastive language-image pretraining models, one or more neural network based language models (e.g., based on recurrent neural networks, gated recurrent units, etc.), one or more transformer language models, one or more large language models, and/or any other type of language model. Additionally, the system(s) may generate the search data using image data representing the images, text data representing text describing the images, and/or any other type of data associated with the images. In some examples, the system(s) may initially segment the images into portions (e.g., patches, tiles, areas, regions, etc.) and then generate the search data associated with the portions.

For instance, the system(s) may receive, obtain, determine, and/or generate one or more settings for segmenting the images into the various portions. As described herein, in some examples, the settings may include, but are not limited to, one or more sizes of the portions, one or more strides between the portions, a number of portions, and/or any other setting. Additionally, a size of a portion may include, but is not limited to, 224 pixels by 224 pixels, 448 pixels by 448 pixels, 672 pixels by 672 pixels, and/or any other sized portion of an image. Furthermore, a stride may include, but is not limited to, 100 pixels, 168 pixels, 250 pixels, 448 pixels, and/or any other number of pixels in a horizontal direction and/or a vertical direction associated with an image. In some examples, the system(s) may segment the images into portions that include a single size and/or a single stride. However, in some examples, the system(s) may segment the images into portions that include varying sizes and/or varying strides. For example, the system(s) may segment the images into first portions that include a first size and first strides and second portions that include a second size and second strides.

To generate the search data for an image, the system(s) may process the image data (and/or additional data, such as the text data) using the model(s). Based at least on the processing, the model(s) may generate embeddings associated with the portions of the image and/or an embedding for an entirety of the image. The system(s) may then store the search data representing the embeddings in one or more databases. Additionally, in some examples, the system(s) may generate additional data that the system(s) stores in the database(s) along with the embeddings and/or in association with the embeddings. For instance, the system(s) may generate and/or store data representing the locations of the portions with respect to the image (e.g., the pixels included in the portions, coordinates associated with points of the portions, segments of the images associated with the portions, etc.), identifiers associated with the portions, an identifier associated with the image for which the portions are segmented, and/or any other information associated with portions of the image and/or the image. Additionally, the system(s) may perform similar processes to generate data associated with one or more additional images represented by the image data.

The system(s) may then use the database(s) when performing one or more searches associated with one or more queries. For instance, the system(s) may receive a query from a client device and/or a user. As described herein, the query may include any type of query, such as a text query, an image query, an embedding query, and/or any other type of query. Additionally, in some examples, the query may include multiple concepts, where a concept is associated with an object and/or a feature that is being searched. For a first example, the query may include text such as “please find images that include vehicles and pedestrians,” where a first concept may be associated with “vehicles” and a second concept may be associated with “pedestrians.” For a second example, a query may include “text that is associated with a first concept, such as “please find vehicles,” along with an image that is associated with a second concept, such as an image of a specific street sign. Furthermore, the query may include one or more timing concepts, such as “show me scenes where there is a first vehicle in front and a second vehicle in back.”

Furthermore, in some examples, the query may include additional information for further filtering the results associated with the query, such as positional information associated with one or more objects and/or features associated with the query. For a first example, the query may include text such as “please find images that include pedestrians located on a left half of the images,” where the concept is then associated with “pedestrians” and the positional information includes “located on a left half of the images.” For a second example, the query may include text such as “please find images that include pedestrians located to a left of vehicles,” where the concepts are associated with “pedestrians” and “vehicles” and the positional information includes the pedestrians being “located to a left” of the vehicles. Still, for a third example, the query may include text such as “show images that include vehicles not located on driveways,” where the concepts are associated with “vehicles” and “driveways” and the positional information includes that the vehicles “are not located on” the driveways. While these are just a few examples of queries that include additional information for filtering results, in other examples, queries may include any other type of information for further filtering results.

The system(s) (e.g., a first component, such as a query optimizer) may then perform an initial search using the query and the database(s). For example, the system(s) may use the query to identify images from the database(s) that are related to one or more of the concept(s) from the query. As described herein, in some examples, the system(s) may use any technique to identify the images from the database(s). For example, the system(s) may process the query using one or more models in order to generate one or more embeddings associated with the query. The system(s) may then use the generated embedding(s) to identify embeddings stored in the database(s) that are related to the generated embedding(s). Additionally, the system(s) may use the identified embeddings to identify the images that are related to the query. For example, if an identified embedding is associated with a portion of an image, the system(s) may use the data associated with the embedding (e.g., the data representing the identifier and/or the location associated with the image) to then identify the image that is associated with the embedding. The system(s) may then perform similar processes to identify one or more additional images.

In some examples, the system(s) may then provide the images to the user, such as by sending image data representing the images to the client device of the user, or by sending a link, address, location, or other information about the image(s) to the client device. However, and as described in more detail herein, in some examples, the system(s) (e.g., a second component, such as a query composer) may perform additional processing to identify at least a portion of the images that are more relevant to the actual query. For instance, such as when the query also includes additional information for further filtering the results, the system(s) may use this additional information to filter the images in order to identify the image(s) that is more relevant to the actual query. For a first example, and using the example above where the query includes “please find images that include pedestrians located on a left half of the images,” the system(s) may use an identified portion of an image to determine that the image represents a pedestrian at a specific location within the image. When filtering the images, the system(s) may then determine to either keep the image when the specific location is in the left half of the image or determine to remove the image when the specific location is in the right half of the image.

For a second example, and using the example above where the query includes “please find images that include pedestrians located to a left of vehicles,” the system(s) may use a first portion of the image to determine that the image represents the pedestrian at a first location within the image and a second portion of the image to determine that the image represents a vehicle at a second location within the image. When filtering, the system(s) many then determine to either keep the image when the first location is to a left of the second location or determine to remove the image when the first location is not to a left of the second location. Still, for a third example, and using the example above where the query includes “show images that include vehicles not located on driveways,” the system(s) may use a first portion of the image to determine that the image represents a vehicle at a first location within the image and one or more second portions of the image to determine that the image represents a driveway at one or more second locations within the image. When filtering, the system(s) may then determine to keep the image when the first location does not include at least one of the second location(s) or determine to remove the image when the first location includes one of the second location(s). In any of these examples, the system(s) may then provide the filtered image(s) to the user, such as by sending image data representing the filtered image(s) to the client device.

As described herein, in some examples, the system(s) may use user feedback to perform additional searches and/or refine the current search. For instance, when displaying the images to a user, the client device may receive one or more inputs selecting at least a set of the images that better represents what the user is searching for with respect to the query. For example, if the initial results include images of vehicles, but the user wants vehicles that are traveling in a specific direction with respect to the images, such as from a left of images to a right of images, then the user may select images that represent vehicles traveling in the specific direction. As described herein, in some examples, the user may select any number of images, such as one image, two images, five images, ten images, and/or any other number of images. The system(s) may then receive, from the client device, data representing the selected image(s).

In some examples, in addition to or alternatively from selecting individual images in their entirety, a user may select (e.g., by circling, drawing a bounding shape, etc.) around a portion(s) of a particular image(s) that the user is most interested in. For example, where an image includes multiple vehicles, and a vehicle is of a particular type, or at a particular location within the image, the user may indicate which vehicle type, position, location, orientation, etc. the user is more interested in, and an embedding may be created for the particular selection and used to further filter the images to identify more images that include vehicles similar to the identified vehicle.

In some examples, the system(s) may then perform an updated search using the selected image(s). For example, the system(s) may use the embedding(s) associated with the selected image(s) to perform the updated search, using one or more of the processes described herein. Additionally, or alternatively, in some examples, the system(s) may perform an updated search using both the initial query and the selected image(s). For example, the system(s) may use the embedding(s) associated with the selected image(s) along with the embedding(s) associated with the initial query to perform the updated search, using one or more of the processes described herein. In any of the examples, the system(s) may then provide the image(s) identified using the updated search to the user, such as by sending image data representing the image(s) to the client device. This process may then continue to repeat for one or more iterations where the user selects one or more images and the system(s) uses the selected image(s) to perform an updated search.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing vision language models (VLMs), systems implementing multi-modal language models, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

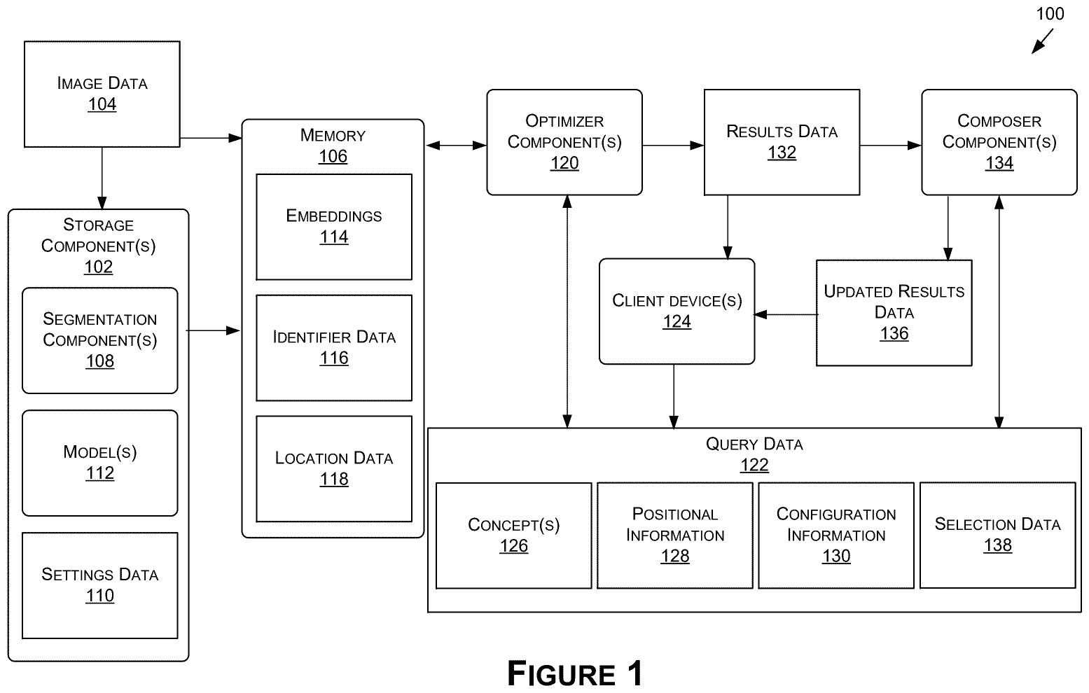

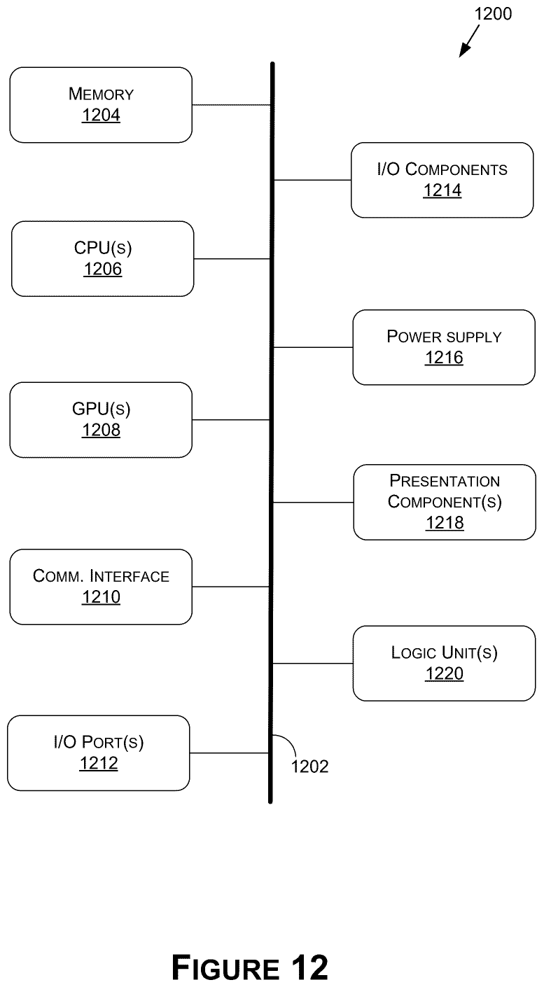

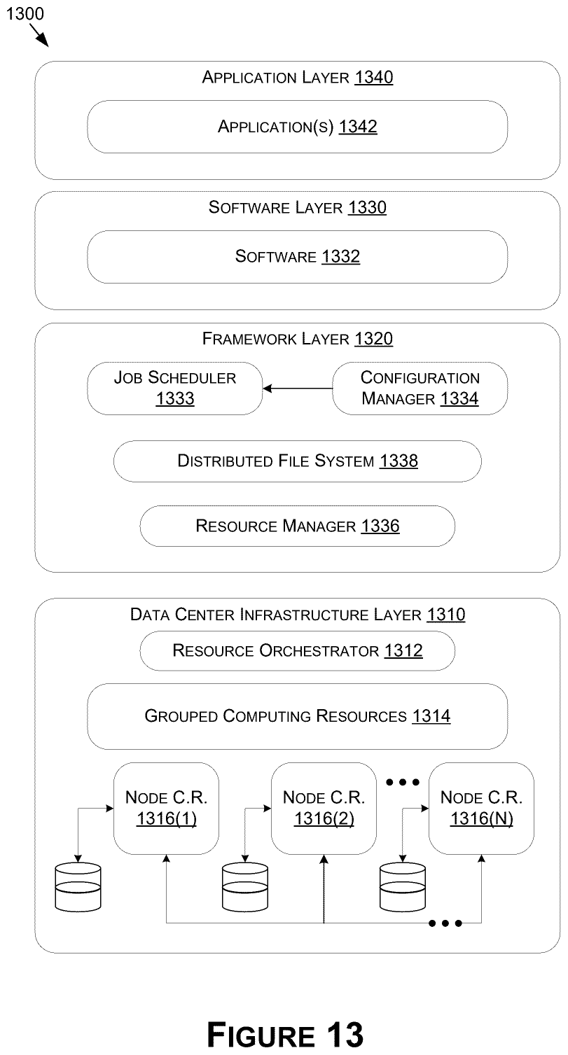

With reference to FIG. 1, FIG. 1 illustrates an example data flow diagram for a process 100 of using data associated with portions of images to perform image retrieval, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1100 of FIGS. 11A-11D, example computing device 1200 of FIG. 12, and/or example data center 1300 of FIG. 13.

The process 100 may include one or more storage components 102 receiving at least image data 104 representing images. As described herein, in some examples, the image data 104 may be generated using one or more machines (e.g., an autonomous vehicle 1100) navigating within an environment. In such examples, the images represented by the image data 104 may represent objects and/or features located within an environment, such as roads, road markings, traffic signals, traffic signs, sidewalks, vehicles, pedestrians, animals, structures, and/or any other object and/or feature that may be located within an environment. However, in other examples, the image data 104 may be generated using any other type of device such that the images represent other types of objects and/or features. While the example of FIG. 1 illustrates the storage component(s) 102 receiving the image data 104 representing the images, in other examples, the storage component(s) 102 may receive other types of sensor data, such as LiDAR data (e.g., point clouds, range images, projection images, top-down or bird's eye view (BEV) images, or other LiDAR data representations), RADAR data (e.g., top-down or BEV images), ultrasonic data, sonar data, a combined or fused sensor data representation (e.g., a BEV representation generated from image, LiDAR, and RADAR data), and/or so forth. Additionally, in some examples, the image data 104 may represent scenes surrounding the machine(s), such as when the machine(s) includes multiple cameras that capture various fields-of-view around the machine(s).

The process 100 may then include the storage component(s) 102 generating data for storage in memory 106 using the image data 104. For instance, and as shown, the process 100 may include the storage component(s) 102 using one or more segmentation components 108 to segment the images into various portions, such as patches, tiles, areas, regions, and/or the like. For example, the segmentation component(s) 108 may receive, obtain, determine, and/or generate settings data 110 representing one or more settings for segmenting the images into the various portions. As described herein, in some examples, the settings may include, but are not limited to, one or more sizes of the portions, one or more strides between the portions, a number of portions, and/or any other setting. Additionally, a size of a portion may include, but is not limited to, 224 pixels by 224 pixels, 448 pixels by 448 pixels, 672 pixels by 672 pixels, and/or any other sized portion of an image. The portions for any individual image may also be of different sizes—e.g., the image may be divided into 224 by 224 pixel portions, and also divided into 672 by 672 pixel portions. Furthermore, a stride may include, but is not limited to, 10 pixels, 100 pixels, 168 pixels, 250 pixels, 448 pixels, and/or any other number of pixels in a horizontal direction and/or a vertical direction associated with an image. In some examples, the segmentation component(s) 108 may segment the images into portions that includes a single size and/or a single stride. However, in some examples, the segmentation component(s) 108 may segment the images into portions that include varying sizes and/or varying strides. For example, the segmentation component(s) 108 may segment the images into first portions that include a first size and first strides and second portions that include a second size and second strides.

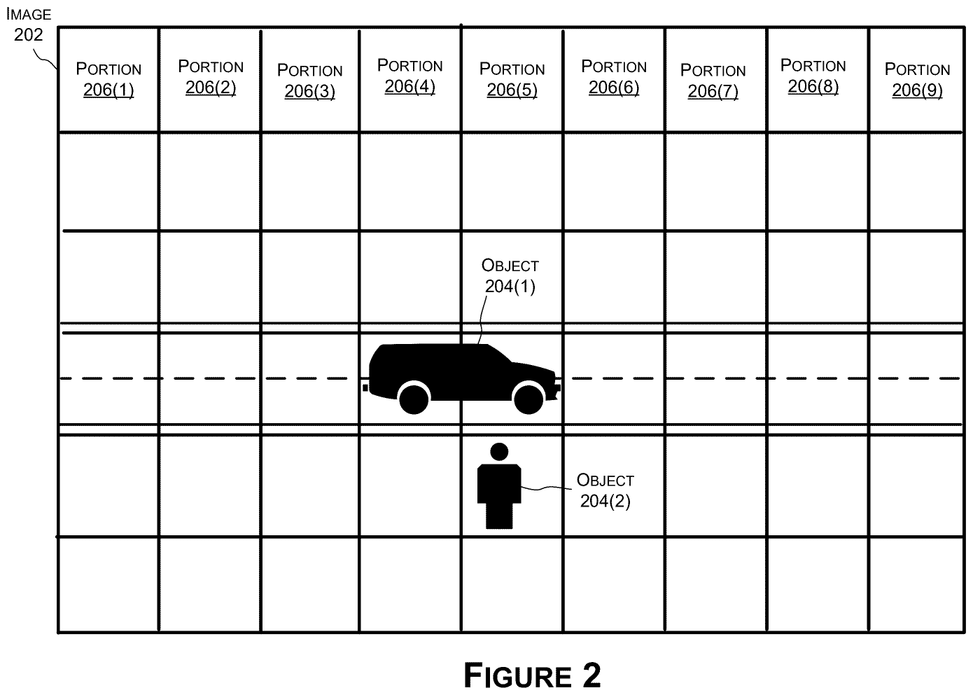

For instance, FIG. 2 illustrates an example of segmenting an image 202 into portions, in accordance with some embodiments of the present disclosure. As shown, the image 202 may represent two objects 204(1)-(2) (also referred to singularly as “object 204” or in plural as “objects 204”). While the example of FIG. 2 illustrates the object 204(1) as including a vehicle and the object 204(2) as including a pedestrian, in other examples, the image 202 may represent any other type of objects. As further shown, the segmentation component(s) 108 may segment the image 202 into various portions 206(1)-(9) (although only one row is labeled for clarity reasons and which may also be referred to as “portion 206” or in plural as “portions 206”). While the example of FIG. 2 illustrates segmenting the image 202 into similar sized portions 206 that do not overlap, in other examples, the segmentation component(s) 108 may segment the image 202 into various sized portions and/or at least some of the portions may overlap. Additionally, while the example of FIG. 2 illustrates segmenting the image 202 into fifty-four portions 206, in other examples, the segmentation component(s) 108 may segment the image 202 into any other number of portions.

Referring back to the example of FIG. 1, the process 100 may include the storage component(s) 102 using one or more models 112 to process at least the image data 104 in order to generate the data for storage in the memory 106. As described herein, in some examples, the model(s) 112 may include one or more language models, such as one or more vision language models, one or more multi-modal language models, one or more contrastive language-image pretraining models, one or more neural network based language models (e.g., based on recurrent neural networks, gated recurrent units, etc.), one or more transformer language models, one or more large language models, and/or any other type of language model. However, in some examples, the model(s) 112 may include any other type of model and/or neural network that is configured to perform one or more of the processes described herein with respect to the model(s) 112. Additionally, and as shown, based at least on processing the image data 104, the model(s) 112 may be configured to generate and/or output embeddings 114 associated with the images and/or the portions of the images.

For instance, and for an image, the model(s) 112 may be configured to generate a first embedding 114 associated with a first portion of the image, a second embedding 114 associated with a second portion of the image, a third embedding 114 associated with a third portion of the image, and/or so forth for one or more additional portions of the image. Additionally, in some examples, the model(s) 112 may be configured to generate an embedding 114 associated with the overall image. The model(s) 112 may then be configured to perform similar processes to generate additional embeddings for one or more additional images represented by the image data 104.

As shown, the process 100 may also include the storage component(s) 102 storing additional data in association with the embeddings 114, such as at least a portion of the image data 104, identifier data 116, and/or location data 118. As described herein, in some examples, the identifier data 116 associated with an embedding 114 may represent at least a first identifier associated with a portion of the image for which the embedding 114 was generated and/or a second identifier associated with the image. Additionally, an identifier may include, but is not limited to, a numerical identifier, an alphabetic identifier, an alphanumerical identifier, a series of symbols, and/or any other type of identifier that may be used to identify an embedding 114, a portion, and/or an image. Furthermore, in some examples, the identifier data 116 may represent additional information associated with the images, such as timestamps indicating when the images were generated. As described in more detail herein, these timestamps may be used to identify scenes that includes multiple images when performing a search, such as images generated using different imaging devices of a same machine.

In some examples, the location data 118 associated with an embedding 114 may represent a location of a portion within an image, where the embedding 114 is generated using the portion of the image. As described herein, the location may include, but is not limited to, locations of pixels associated with the portion, coordinates for specific pixels (e.g., one or more corners) associated with the portion, a reference location associated with the portion (e.g., first portion, a second portion, top-left portion, a top-right portion, a corner, a middle, etc.), and/or any other type of location associated with the portion.

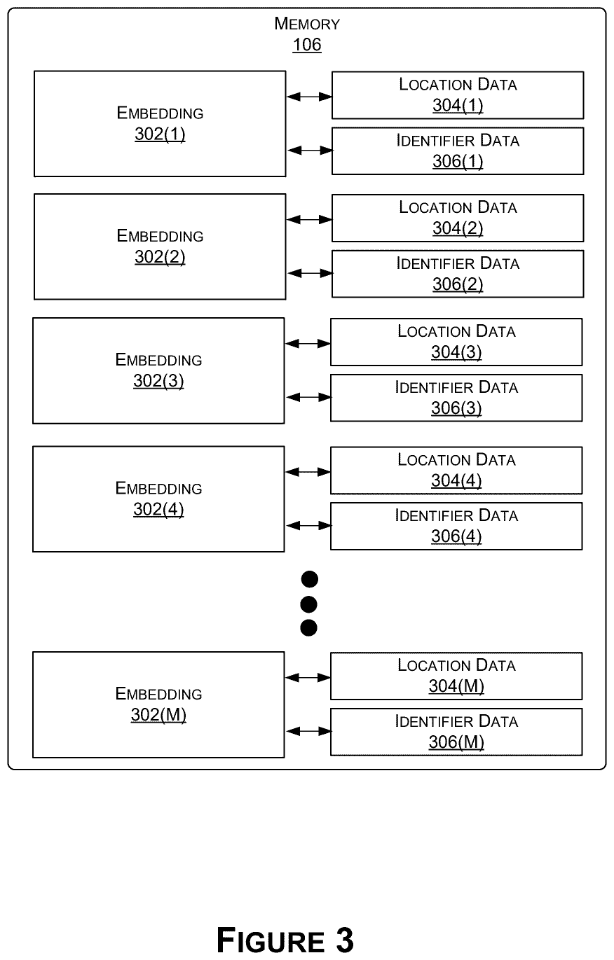

For instance, FIG. 3 illustrates an example of generating and/or storing data associated with the image 202, in accordance with some embodiments of the present disclosure. As shown, the storage component(s) 102 may use the model(s) 112 to generate embeddings 302(1)-(M) (which may be similar to, and/or include, the embeddings 114) associated with the portions 206 of the image 202. For instance, the model(s) 112 may generate the first embedding 302(1) associated with the first portion 206(1), the second embedding 302(2) associated with the second portion 206(2), the third embedding 302(3) associated with the third portion 206(3), the fourth embedding 302(4) associated with the fourth portion 206(4), and/or so forth. Additionally, the model(s) 112 may generate the embedding 302(M) associated with the image 202. The storage component(s) 102 may then store the embeddings 302(1)-(M) in the memory 106.

The storage component(s) 102 may then generate location data 304(1)-(M) associated with the portions 206 and/or the embeddings 302(1)-(M). For instance, the first location data 304(1) may represent a first location of the first portion 206(1) within the image 202, the second location data 304(2) may represent a second location of the second portion 206(2) within the image 202, the third location data 304(3) may represent a third location of the third portion 206(3) within the image 202, the fourth location data 304(4) may represent a fourth location of the fourth portion 206(4) within the image 202, and/or so forth. For a first example, the first location data 304(1) may represent location 1, locations of pixels associated with the first portion 206(1), locations of coordinates associated with the first portion 206(1), and/or any other location information. For a second example, the second location data 304(2) may represent location 2, locations of pixels associated with the second portion 206(2), locations of coordinates associated with the second portion 206(2), and/or any other location information.

The storage component(s) 102 may also generate identifier data 306(1)-(M) associated with the portions 206 and/or the embeddings 302(1)-(M). For instance, the first identifier data 306(1) may represent a first identifier associated with the first portion 206(1) and/or an overall identifier associated with the image 202, the second identifier data 306(2) may represent a second identifier associated with the second portion 206(2) and/or the overall identifier associated with the image 202, the third identifier data 306(3) may represent a third identifier associated with the third portion 206(3) and/or the overall identifier associated with the image 202, the fourth identifier data 306(4) may represent a fourth identifier associated with the fourth portion 206(4) and/or the overall identifier associated with the image 202, and/or so forth. This way, and as described in more detail herein, when performing a search, the location data 304(1)-(M) and/or the identifier data 306(1)-(M) may be used to identify the portions 206 associated with the identified embeddings 302(1)-(M) and/or the image 202.

Referring back to the example of FIG. 1, the process 100 may include one or more optimizer components 120 receiving query data 122 from at least a client device 124, where the query data 122 represents at least a query. As described herein, in some examples, the query may include any type of query, such as a text query, an image query, an embedding query, and/or any other type of query. Additionally, in some examples, the query may include one or more concepts 126, where a concept 126 may be associated with an object and/or features for which the user is searching. For a first example, the query may include text such as “please find images that represent vehicles,” where a concept 126 may then be associated with “vehicles.” For a second example, a query may include text that is associated with a first concept 126, such as “please find vehicles,” along with an image that is associated with a second concept 126, such as an image of a specific street sign. Still, for a third example, the query may include text such as “please find vehicles next to pedestrians,” where a first concept 126 may then be associated with “vehicles” and a second concept 126 may be associated with “pedestrians.”

Furthermore, in some examples, the query may include additional information for further filtering the results associated with the query, such as positional information 128 associated with one or more concepts 126 associated with the query. As described herein, the positional information 128 may indicate a location within an image, a location of a concept 126 with respect to another concept 126, an indication that an image should not include a concept 126, an indication that a location within the image should not include a concept 126, and/or any other type of location information. For a first example, the query may include text such as “please find images that include pedestrians located on a left half of the images,” where the concept 126 may then be associated with “pedestrians” and the positional information 128 includes “located on a left half” of the images. For a second example, the query may include text such as “please find images that include pedestrians located to a left of vehicles,” where the concepts 126 may be associated with “pedestrians” and “vehicles” and the positional information 128 includes the pedestrians being “located to a left of” the vehicles. Still, for a third example, the query may include text such as “show images that include vehicles not located on driveways,” where the concepts 126 may be associated with “vehicles” and “driveways” and the positional information 128 includes that the vehicles “are not located on” the driveways.

In some examples, the positional information 128 may further include a timing aspect, such as when searching for scenes. For example, the positional information 128 may be associated with queries that includes searching for a first object located on a first side of a machine and a second object located on a second side of the machine. These types of queries may be important when trying to identify images generated by a single machine, but with using different imaging devices. For instance, since the positional information 128 is associated with two different objects that are located on two different sides of the machine, then the images may need to be generated using different imaging devices and at approximately a similar time.

As further shown, in some examples, the query may include configuration information 130 associated with performing the search. As described herein, the configuration information 130 may indicate one or more databases for performing the search, one or more types of images being searched, a minimum number of results to provide, a maximum number of results to provide, and/or any other information for configuring the search.

The process 100 may then include the optimizer component(s) 120 using the memory 106 to perform a search in order to identify images that are related to the query. For instance, the optimizer component(s) 120 may use the query to identify images that are related to one or more of the concepts 126 from the query. As described herein, in some examples, the optimizer component(s) 120 may use any technique to identify the images. For example, the optimizer component(s) 120 may process the query using one or more models (e.g., the model(s) 112) in order to generate one or more embeddings (which may also be represented as an embedding(s) 114) associated with the query. The optimizer component(s) 120 may then use the generated embedding(s) to identify embeddings 114 stored in the memory 106 that are related to the generated embedding(s). Additionally, the optimizer component(s) 120 may use the identified embeddings 114 to identify the images that are related to the query.

For instance, if an identified embedding 114 is associated with a portion of an image, the optimizer component(s) 120 may use the data associated with the embedding 114 (e.g., the identifier data 116 and/or the location data 118) to then identify the image that is associated with the embedding 114. For example, since the data (e.g., the identifier data 116) associated with the embedding 114 may also associate the embedding 114 with a portion of the image and/or the image, the optimizer component(s) 120 may use that association to identify the image. The optimizer component(s) 120 may then perform similar processes to identify one or more additional images that are also related to the query.

In some examples, the optimizer component(s) 120 may then provide the client device 124 with results associated with the search. For instance, and as shown, the optimizer component(s) 120 may provide the results by sending, to the client device 124, results data 132 representing the images identified for the search. This way, the client device 124 may use the results data 132 to display at least a portion of the images to the user. Additionally, in some examples, in addition to the images, the results data 132 may represent additional information associated with the search, such as the locations of the objects and/or features as represented by the images. For example, the results data 132 may represents the locations of the portions of the images for which the objects and/or the features are represented.

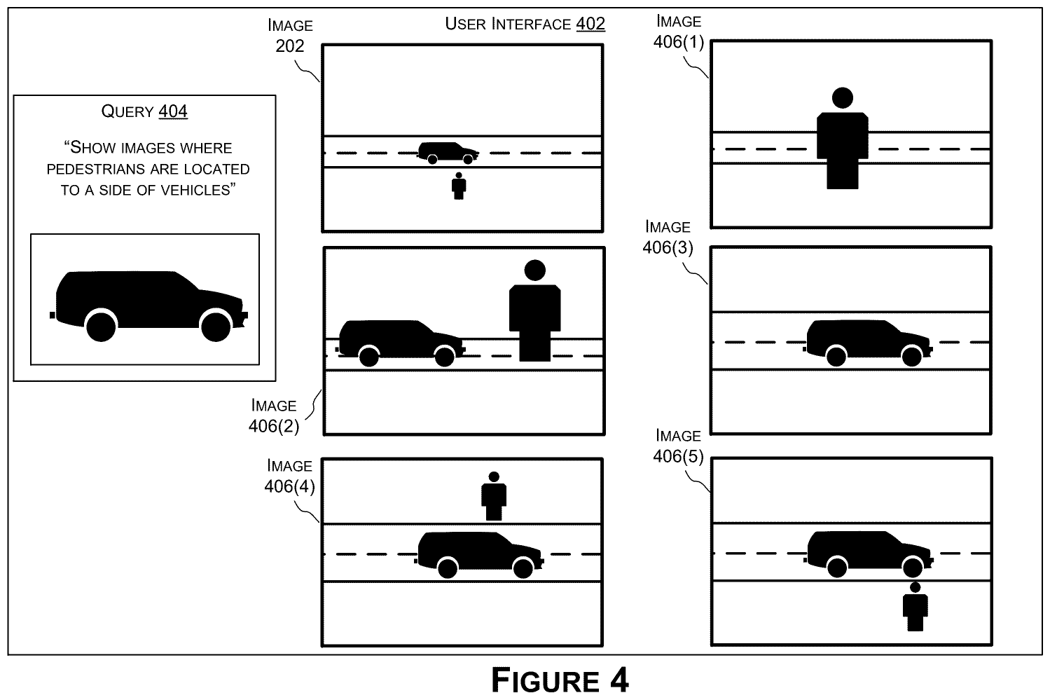

For instance, FIG. 4 illustrates an example of providing results associated with a query, in accordance with some embodiments of the present disclosure. As shown, the client device 124 may display a user interface 402 that the user uses to perform the search. For instance, the user interface 402 may include a portion for inputting a query 404. In the example of FIG. 4, the query 404 may include both text, such as “Show images where pedestrians are located to a side of vehicles,” and an image, such as an image input by the user that represents a vehicle. As such, the optimizer component(s) 120 may perform one or more of the processes described herein to identify results associated with the query 404, where the results include at least images 202 and 406(1)-(5). In some examples, the optimizer component(s) 120 may identify the results based at least on the concepts included in the query 404.

For instance, the query 404 may include at least a first concept that is associated with “pedestrians” and a second concept that is associated with “vehicles.” As such, the optimizer component(s) 120 may identify both the images 202, 406(1)-(2), and 406(4)-(5) that represent pedestrians as well as the images 202 and 406(2)-(5) that represent vehicles. The optimizer component(s) 120 may then provide all of those results back to the user. While the example of FIG. 4 illustrates the optimizer component(s) 120 as identifying and/or providing the six images 202 and 406(1)-(5) that represent pedestrians and/or vehicles, in other examples, the optimizer component(s) 120 may identify and/or provide any number of images.

Referring back to the example of FIG. 1, in some examples, the process 100 may include one or more composer components 134 refining the results using at least a portion of the query. For instance, such as when the query also includes the additional positional information 128 for further filtering the results, the composer component(s) 134 may use this additional positional information 128 to filter the images in order to identify the image(s) that is more relevant to the actual query. For a first example, and using the example above where the query includes “please find images that include pedestrians located on a left half of the images,” the composer component(s) 134 may use the location data 118 for an identified portion of an image that represents a pedestrian to determine that the image represents the pedestrian at a specific location within the image. When filtering the images, the composer component(s) 134 may then determine to either keep the image when the specific location is in the left half of the image or determine to remove the image when the specific location is in the right half of the image.

For a second example, and using the example above where the query includes “please find images that include pedestrians located to a left of vehicles,” the optimizer component(s) 120 may use the location data 118 for a first portion of the image that represents a pedestrian to determine that the image represents the pedestrian at a first location within the image and the location data 118 for a second portion of the image that represents a vehicle to determine that the image represents the vehicle at a second location within the image. When filtering, the composer component(s) 134 may then determine to either keep the image when the first location is to a left of the second location or determine to remove the image when the first location is not to a left of the second location.

For a third example, and using the example above where the query includes “show images that include vehicles not located on driveways,” the composer component(s) 134 may use the location data 118 for a first portion of the image that represents a vehicle to determine that the image represents the vehicle at a first location within the image and the location data 118 for one or more second portions of the image that represent a driveway to determine that the image represents the driveway at one or more second locations within the image. When filtering, the composer component(s) 134 may then determine to keep the image when the first location does not include at least one of the second location(s) or determine to remove the image when the first location includes one of the second location(s). While these are just a few example techniques of how the composer component(s) 132 may filter images based at least on the positional information 128, in other examples, the composer component(s) 132 may filter images using additional and/or alternative techniques based at least on the positional information 128.

Still, for a fourth example, such as where the query is associated with a scene, such as “show me images where a first object is located on a first side of a machine and a second object is located on a second side of the machine,” then the composer component(s) 134 may use timing aspects when identifying the images. For instance, the composer component(s) 120 may identify scenes that includes multiple images, such as a scene that includes a first image representing the first object on the first side and a second image representing the second object on the second side. In some examples, the composer component(s) 134 may identify the scene using the additional information associated with the images, such as the positional information 128 indicating that the images were captured at approximately a similar time (e.g., using timestamps associated with the images). In other words, the composer component(s) 134 may use the timestamps for the images to generate these scenes for complex queries.

For example, the composer component(s) 120 may identify a first image that represents the first object located on the first side of a machine and also identify a second image that represents the second object located on the second side of the machine. The composer(s) component 120 may then use the positional information 128 to determine that the images were generated at approximately a similar time. As such, the composer component(s) 120 may generate a scene that includes the images.

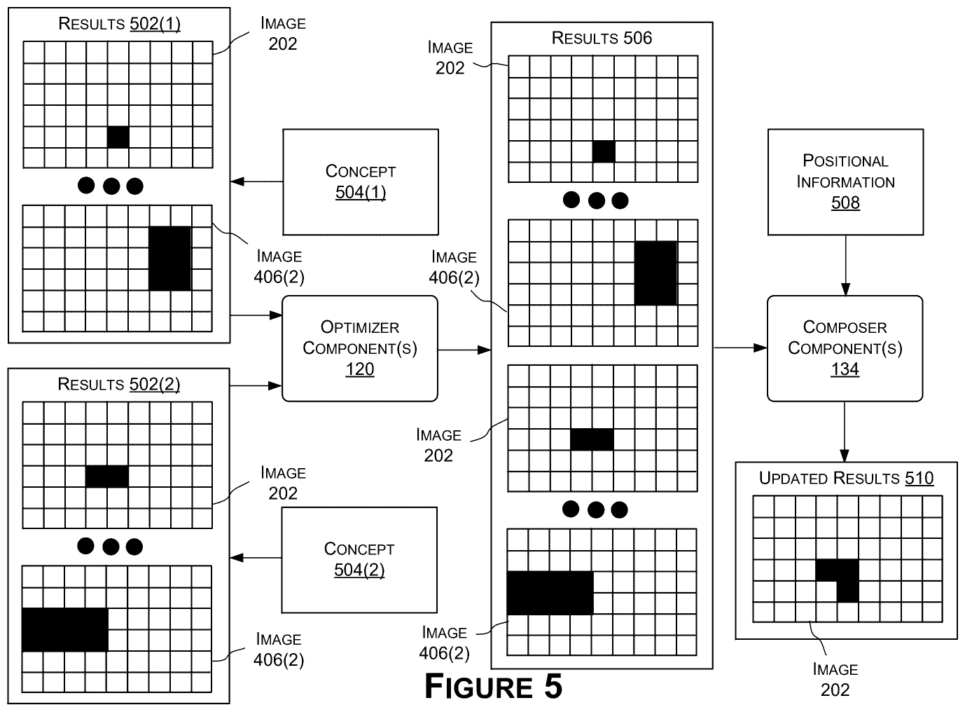

For instance, and for more detail, FIG. 5 illustrates an example of filtering results associated with a query using additional information, in accordance with some embodiments of the present disclosure. As shown, based at least on performing one or more of the processes described herein, the optimizer component(s) 120 may identify at least first results 502(1) associated with a first concept 504(1), such as “pedestrians” from the query 404 in the example of FIG. 4, and second results 502(2) associated with a second concept 504(2), such as “vehicles” from the query 404 in the example of FIG. 4. As such, the first results 502(1) may include at least the image 202 and the image 406(2) (and/or the images 406(1) and 406(4)-(5)), which represent pedestrians, and the second results 502(2) may include at least the image 202 and the image 406(2) (and/or the images 406(3)-(5)), which represent vehicles. Additionally, the example of FIG. 5 illustrates the portions of the images 202 and 406(2) that represent the pedestrians, which is indicated by the dark squares, and the portions of the images 202 and 406(2) that represent the vehicles, which is indicated by the grey squares.

As such, the optimizer component(s) 120 may generate initial results 506 that include at least the images 202 and 406(2) (and/or the images 406(1) and 406(3)-(5)). However, the composer component(s) 134 may then refine the results using at least positional information 508 from the query 404 in the example of FIG. 4, where the positional information 508 may indicate that the pedestrians are to be located “to a side” of the vehicles. For instance, the composer component(s) 134 may determine one or more first locations associated with the pedestrian as represented by the image 202, which is again illustrated by the dark squares, and one or more second locations associated with the vehicle as represented by the image 202, which is again illustrated by the grey squares. The composer component(s) 134 may then use the first location(s) and the second location(s) to determine that the pedestrian is located to the side of the vehicle in the image 202. As such, the composer component(s) 134 may determine to include the image 202 in updated results 510.

However, as also shown, the composer component(s) 134 may determine one or more first locations associated with the pedestrian as represented by the image 406(2), which is again illustrated by the dark squares, and one or more second locations associated with the vehicle as represented by the image 406(2), which is again illustrated by the grey squares. The composer component(s) 134 may then use the first location(s) and the second location(s) to determine that the pedestrian is not located to the side of the vehicle in the image 406(2), but rather in front of the vehicle. As such, the composer component(s) 134 may determine not to include the image 406(2) in the updated results 510. In some examples, the composer component(s) 134 may then perform similar processes for one or more additional images 406(1) and 406(3)-(5).

Referring back to the example of FIG. 1, in some examples, the composer component(s) 134 may then provide the client device 124 with updated results associated with the search. For instance, and as shown, the composer component(s) 134 may provide the results by sending, to the client device 124, updated results data 136 representing the image(s) identified for the search. This way, the client device 124 may use the updated results data 136 to display at least a portion of the image(s) to the user.

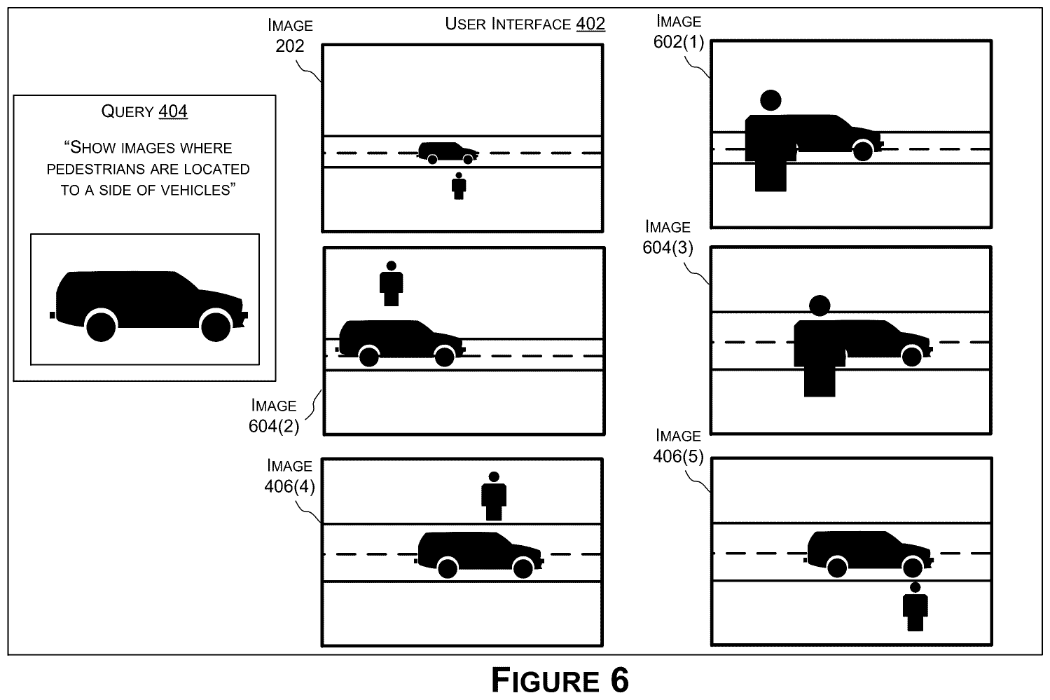

For instance, FIG. 6 illustrates an example of providing updated results associated with a query, in accordance with some embodiments of the present disclosure. As shown, based at least on performing one or more of the processes described herein, the composer component(s) 134 may filter the images in order to keep at least the images 202 and 406(4)-(5) from the example of FIG. 4 in the updated results. This may be because the images 202 and 406(4)-(5) represent pedestrians located to sides of vehicles. Additionally, the composer component(s) 134 may have filtered additional images, which were not illustrated with respect to the example of FIG. 4, in order to identify additional images 602(1)-(3) to include in the updated results. This may also be because the images 602(1)-(3) also represent pedestrians located to sides of vehicles.

Referring back to the example of FIG. 1, in some examples, process 100 may include using user feedback to perform additional searches and/or refine the current search. For instance, when displaying the images to a user, the client device 124 may receive one or more inputs selecting at least a set of the images that better represents what the user is searching with respect to the query. For example, if the initial results include images of vehicles, but the user wants vehicles that are traveling in a specific direction with respect to the images, such as from a left of images to a right of images, then the user may select images that represent vehicles traveling in the specific direction. As described herein, in some examples, the user may select any number of images, such as one image, two images, five images, ten images, and/or any other number of images. The optimizer component(s) 120 (and/or the composer component(s) 134) may then receive, from the client device 124, selection data 138 representing the selected image(s).

In some examples, the optimizer component(s) 120 may then perform an updated search using the selected image(s). For example, the optimizer component(s) 120 may use the embedding(s) 114 associated with the selected image(s) to perform the updated search, using one or more of the processes described herein. Additionally, or alternatively, in some examples, the optimizer component(s) 120 may perform an updated search using both the initial query and the selected image(s). For example, the optimizer component(s) 120 may use the embedding(s) 114 associated with the selected image(s) along with the embedding(s) 114 associated with the initial query to generate an updated query for performing the updated search, using one or more of the processes described herein. In any of the examples, the optimizer component(s) 120 may then provide the image(s) identified using the updated search to the user, such as by sending results data 132 representing the image(s) to the client device 124. This process may then continue to repeat for one or more iterations where the user selects one or more images and the optimizer component(s) 120 uses the selected image(s) to perform an updated search.

Additionally, or alternatively, in some examples, the composer component(s) 134 may receive the results data 132 from the optimizer component(s) 120 that includes the image(s) associated with the updated search. The composer component(s) 134 may then perform one or more of the processes described herein to refine the results using at least a portion of the updated query. For instance, such as when the initial query included the additional positional information 128 for further filtering the results, the composer component(s) 134 may use this additional positional information 128 to filter the image(s) in order to identify one or more images that are more relevant to the actual query, using one or more of the processes described herein. As such, the optimizer component(s) 120 and the composer component(s) 134 may together update the results using the user feedback and then further refine the results to better represent the query from the user.

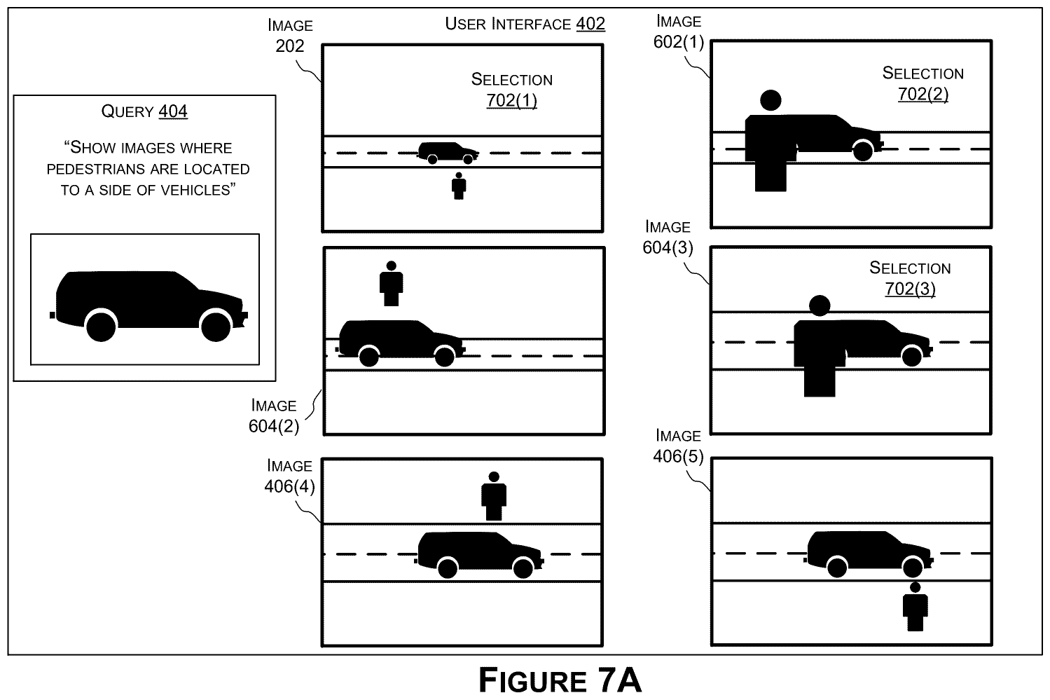

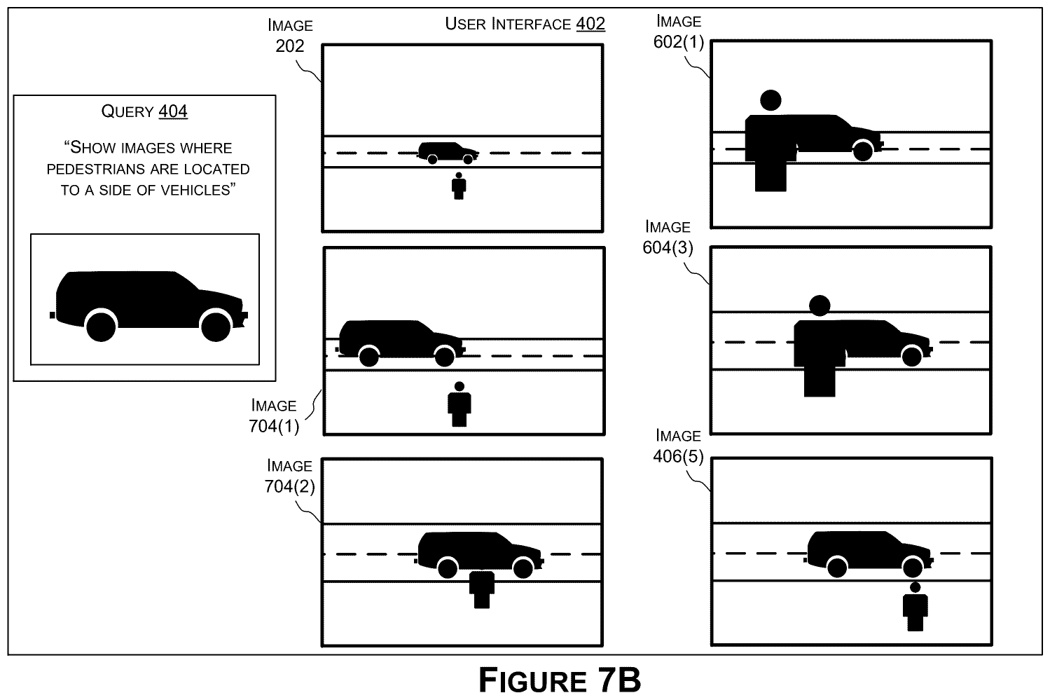

For instance, FIGS. 7A-7B illustrate an example of providing updated results associated with a query and user feedback, in accordance with some embodiments of the present disclosure. As shown by the example of FIG. 7A, the user may select at least the images 202, 604(1) and 604(3), which is indicated by selections 702(1)-(3). In some examples, the user may use any technique to select the images 202, 604(1), and 604(3), such as by providing a physical input (e.g., using a pointer, touching the display, etc.), providing a voice input, and/or providing any other type of input. As shown, the images 202, 604(1), and 604(3) all include similar characteristics, such as the pedestrians being located to a right side of the vehicles. While the example of FIG. 7A only illustrates the user as selecting the three images 202, 604(1), and 604(3), in other examples, the user may select any number of images (e.g., also select the 406(5)).

Next, and as illustrated by the example of FIG. 7B, based at least on the selections 702(1)-(3) from the user, the optimizer component(s) 120 and/or the composer component(s) 134 may perform one or more of the processes described herein to update the results for the user. For instance, and as shown, in addition to the images 202, 604(1), 604(3), and 604(5) that represent the pedestrians located to a right side of the vehicles, the optimizer component(s) 120 and/or the composer component(s) 134 may identify images 704(1)-(2) that also represent pedestrians located to a right side of vehicles. As described herein, in some examples, the optimizer component(s) 120 and/or the composer component(s) 134 may use any technique to perform this updated search, such as by using the embeddings associated with the selected images 202, 604(1), and 604(3) and/or one or more embeddings associated with the initial search.

In some examples, the processes associated with the example of FIGS. 7A-7B may continue to repeat in order to continue refining the search. This way, a user may be able to perform a better search even when describing one or more objects using words may be difficult.

Referring back to the example of FIG. 1, in some examples, the process 100 may be performed by one or more systems, servers, devices, machines, and/or so forth. For instance, the process 100 may be performed using one or more of an example computing device 1200 and/or an example data center 1300. For example, the storage component(s) 102, the memory 106, the optimizer component(s) 120, and/or the composer component(s) 134 may be stored on one or more memories of the example computing device 1200 and/or the example data center 1300 and/or may be executed using one or more processors of the example computing device 1200 and/or the example data center 1300, where the one or more memories and/or the one or more processors are described in more detail herein. Additionally, in these examples, the example computing device 1200 and/or the example data center 1300 may communicate with the client device(s) 124 using one or more techniques in order to provide this searching capability.

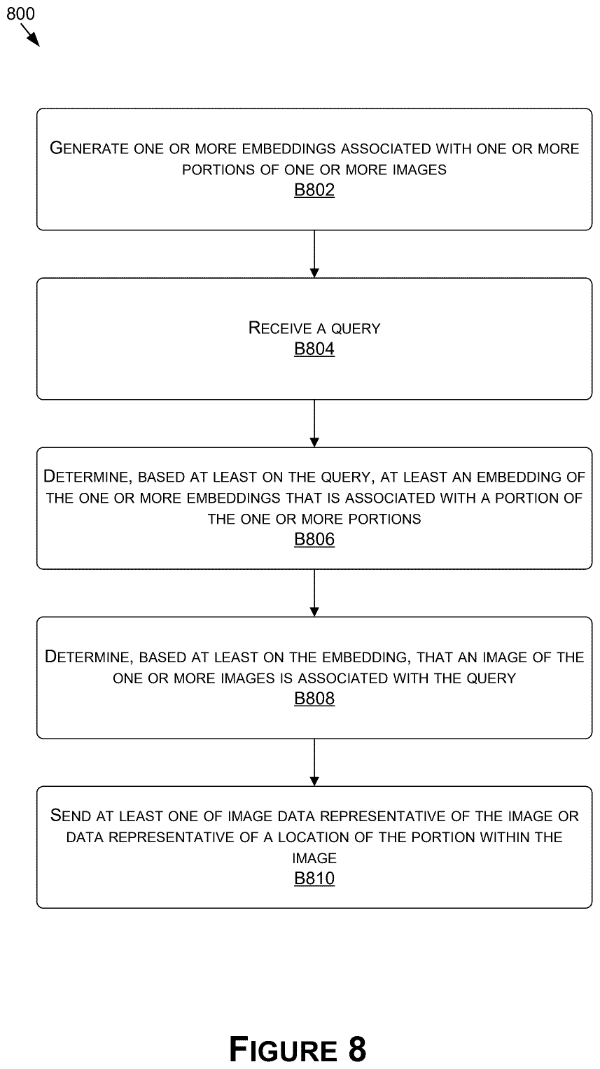

Now referring to FIGS. 8-10, each block of method 800, 900, and 1000, described herein, comprises a computing process that may be performed using any combination of hardware, firmware, and/or software. For instance, various functions may be carried out by a processor executing instructions stored in memory. The methods 800, 900, and 1000 may also be embodied as computer-usable instructions stored on computer storage media. The methods 800, 900, and 1000 may be provided by a standalone application, a service or hosted service (standalone or in combination with another hosted service), or a plug-in to another product, to name a few. In addition, these methods 800, 900, and 1000 described, by way of example, with respect to FIG. 1. However, these methods 800, 900, and 1000 may additionally or alternatively be executed by any one system, or any combination of systems, including, but not limited to, those described herein.

FIG. 8 illustrates a flow diagram showing a method 800 for performing image retrieval using image segmentation, in accordance with some embodiments of the present disclosure. The method 800, at block B802, may include generating one or more embeddings associated with one or more portions of one or more images. For instance, the storage component(s) 102 may generate the embedding(s) 114 associated with the portion(s) of the image(s), where the image(s) is represented by the image data 104. In some examples, the storage component(s) 102 may also generate the identifier data 116 and/or the location data 118 associated with the embedding(s) 114. The optimizer component(s) 120 may then obtain and/or access the embedding(s) 114 using the memory 106. As described herein, in some examples, the optimizer component(s) 120 may further obtain and/or access the identifier data 116 and/or the location data 1118 associated with the embedding(s) 114.

The method 800, at block B804, may include receiving a query. For instance, the optimizer component(s) 120 may receive the query data 122 from the client device 124 where the query data 122 represents the query. As described herein, in some examples, the query may include one or more concepts 126 associated with one or more objects and/or features, positional information 128 associated with the concept(s), and/or configuration information 130 for performing the query. In some examples, the client device(s) 124 may receive the query using a user interface.

The method 800, at block B806, may include determining, based at least on the query, at least an embedding of the one or more embeddings that is associated with a portion of the one or more portions. For instance, the optimizer component(s) 120 may determine, based at least on the query, the embedding 114 from the embedding(s) 114. Additionally, the optimizer component(s) 120 may then determine that the embedding 114 is associated with the portion. As described herein, in some examples, the optimizer component(s) 120 may determine that the embedding 114 is associated with the portion using the identifier data 116 and/or the location data 118 associated with the embedding 114.

The method 800, at block B808, may include determining, based at least on the embedding, that an image of the one or more images is associated with the query. For instance, the optimizer component(s) 120 may determine, based at least on the embedding 114, that the image is associated with the embedding 114. As described herein, in some examples, the optimizer component(s) 120 may determine that the portion is associated with the embedding 114 using the identifier data 116 and/or the location data 118 associated with the embedding 114. Additionally, in some examples, the optimizer component(s) 120 may determine additional information associated with the portion and/or the image, such as the location associated with the portion within the image.

The method 800, at block B810, may include sending at least one of image data representative of the image or data representative of a location of the portion within the image. For instance, the optimizer component(s) 120 may generate the results data 132 representing the image and/or the location of the portion within the image. The optimizer component(s) 120 may then send the results data 132 to the client device 124. In some examples, and as further described herein, the composer component(s) 134 may refine the results using the results data 132 and/or the positional information 128. The composer component(s) 134 may then send the updated results data 136 representing the updated results to the client device 124.

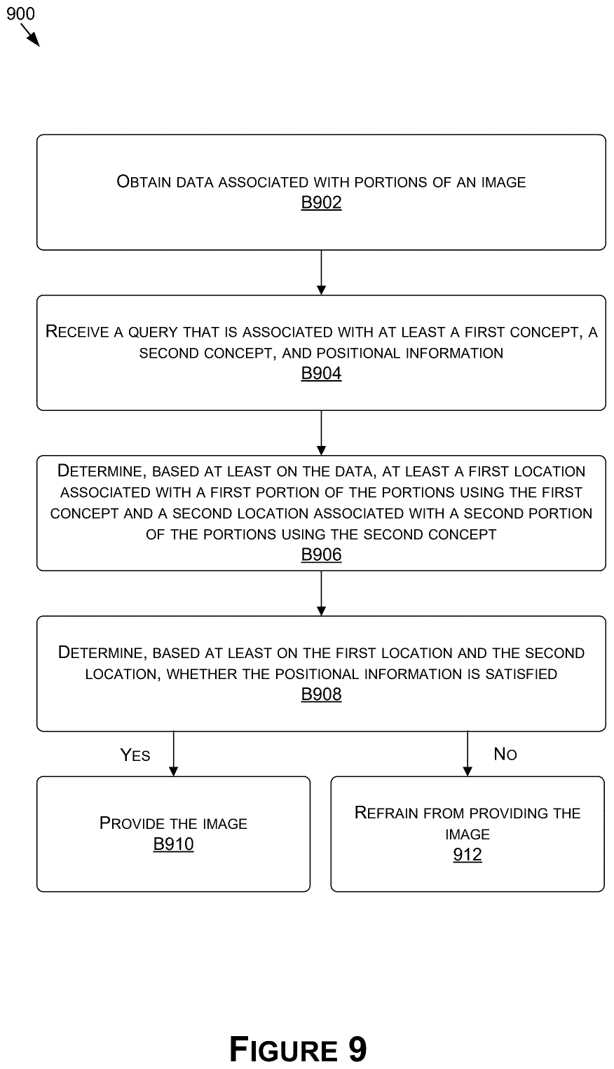

FIG. 9 illustrates a flow diagram showing a method 900 for combining query results in order to determine one or more images associated with a scenario, in accordance with some embodiments of the present disclosure. The method 900, at block B902, may include obtaining data associated with portions of an image. For instance, the composer component(s) 134 may obtain the data associated with the portions of the image. As described herein, in some examples, the data may include at least data representing the embeddings 114, the identifier data 116, the location data 118, and/or any other type of data. Additionally, or alternatively, in some examples, the data may include the results data 132 representing the results for an initial search performed by the optimizer component(s) 120 using a query represented by the query data 122.

The method 900, at block B904, may include receiving a query that is associated with at least a first concept, a second concept, and positional information. For instance, the composer component(s) 134 may receive the query that is associated with at least the first concept 126, the second concept, 126, and the positional information 128. As described herein, the first concept 126 may be associated with a first type of object and/or feature, the second concept 126 may be associated with a second type of object and/or feature, and the positional information 128 may include one or more locations associated with the concepts 126. In some examples, the first type of object and/or feature may be different than the second type of object and/or feature. In some examples, the first type of object and/or features may be the same as the second type of object and/or features.

The method 900, at block B906, may include determining, based at least on the data, at least a first location associated with a first portion of the portions using the first concept and a second location associated with a second portion of the portions using the second concept. For instance, the composer component(s) 134 may determine, using at least the data, that the first portion of the image is associated with the first concept 126 and the second portion of the image is associated with the second concept 126. The composer component(s) 134 may then determine, using the data, that the first portion is associated with the first location within the image and the second portion is associated with the second location within the image.

The method 900, at block B908, may include determining, based at least on the first location and the second location, whether the positional information is satisfied. For instance, the composer component(s) 134 may determine whether the positional information 128 is satisfied using at least the first location associated with the first concept 126 and the second location associated with the second concept 126. As described herein, the composer component(s) 134 may determine that the positional information 128 is satisfied based at least on the first location being within an indicated direction and/or location with respect to the second location or determine that the positional information 128 is not satisfied based at least on the first location being outside of the indicated direction and/or location with respect to the second location.

If, at block B908, it is determined that the positional information is satisfied, then the process 900, at block B910, may include providing the image. For instance, if the composer component(s) 134 determines that the positional information 128 is satisfied, then the composer component(s) 134 may send the updated results data 136 representing the image to the client device 124. However, if, at block B908, it is determined that the positional information is not satisfied, then the process 900, at block B912, may include refraining from providing the image. For instance, if the composer component(s) 134 determines that the positional information 128 is not satisfied, then the composer component(s) 134 may refrain from sending the updated results data 136 representing the image to the client device 124.

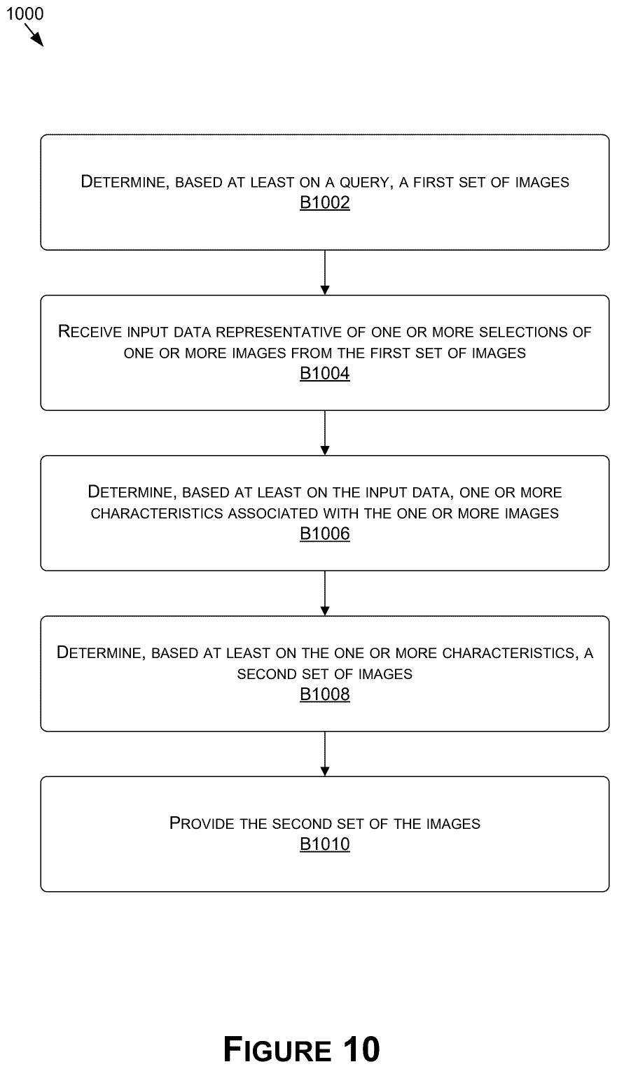

FIG. 10 illustrates a flow diagram showing a method for updating a search using user feedback, in accordance with some embodiments of the present disclosure. The method 1000, at block B1002, may include determining, based at least on a query, a first set of images. For instance, the optimizer component(s) 120 (and/or the composer component(s) 134) may receive the query data 122 representing at least the query. The optimizer component(s) 120 may then use the query to determine the first set of images. As described herein, in some examples, the optimizer component(s) 120 may determine the first set of images using the embeddings 114, the identifier data 116, and/or the location data 118 associated with at least one of portions of the first set of images and/or the first set of images.

The method 1000, at block B1004, may include receiving input data representative of one or more selections of one or more images from the first set of images. For instance, the optimizer component(s) 120 (and/or the composer component(s) 134) may receive the input data representing the selection(s) of the image(s) from the first set of images. As described herein, in some examples, a user may select the image(s) using the client device 124, such as when the client device 124 is displaying the first set of images.

The method 1000, at block B1006, may include determining, based at least on the input data, one or more characteristics associated with the one or more images. For instance, the optimizer component(s) 120 (and/or the composer component(s) 134) may determine the characteristic(s) associated with the image(s). As described herein, in some examples, the characteristic(s) may include positional information associated with one or more concepts associated with the query, types of concepts associated with the query, and/or any other characteristic.

The method 1000, at block B1008, may include determining, based at least on the one or more characteristics, a second set of images. For instance, the optimizer component(s) 120 (and/or the composer component(s) 134) may determine the second set of images based at least on the characteristic(s). For instance, the second set of images may represent the characteristic(s). Additionally, in some examples, the optimizer component(s) 120 may determine the second set of images using additional information, such as the initial query. Furthermore, in some examples, the optimizer component(s) 120 may determine the second set of images using the embeddings 114, the identifier data 116, and/or the location data 118 associated with at least one of portions of the second set of images and/or the second set of images.

The method 1000, at block B1010, may include providing the second set of images. For instance, the optimizer component(s) (and/or the composer component(s) 134) may provide the second set of images to the client device 124. As described herein, in some examples, the optimizer component(s) 120 may provide the second set of images by sending, to the client device 124, the results data 132 (and/or the updated results data 136) representing the second set of images.

### Example Autonomous Vehicle

FIG. 11A is an illustration of an example autonomous vehicle 1100, in accordance with some embodiments of the present disclosure. The autonomous vehicle 1100 (alternatively referred to herein as the “vehicle 1100”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1100 may be capable of functionality in accordance with one or more of Level 3-Level 5 of the autonomous driving levels. The vehicle 1100 may be capable of functionality in accordance with one or more of Level 1-Level 5 of the autonomous driving levels. For example, the vehicle 1100 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1100 or other machine, such as being fully autonomous, being highly autonomous, being conditionally autonomous, being partially autonomous, providing assistive autonomy, being semi-autonomous, being primarily autonomous, or other designation.

The vehicle 1100 may include components such as a chassis, a vehicle body, wheels (e.g., 2, 4, 6, 8, 18, etc.), tires, axles, and other components of a vehicle. The vehicle 1100 may include a propulsion system 1150, such as an internal combustion engine, hybrid electric power plant, an all-electric engine, and/or another propulsion system type. The propulsion system 1150 may be connected to a drive train of the vehicle 1100, which may include a transmission, to enable the propulsion of the vehicle 1100. The propulsion system 1150 may be controlled in response to receiving signals from the throttle/accelerator 1152.

A steering system 1154, which may include a steering wheel, may be used to steer the vehicle 1100 (e.g., along a desired path or route) when the propulsion system 1150 is operating (e.g., when the vehicle is in motion). The steering system 1154 may receive signals from a steering actuator 1156. The steering wheel may be optional for full automation (Level 5) functionality.

The brake sensor system 1146 may be used to operate the vehicle brakes in response to receiving signals from the brake actuators 1148 and/or brake sensors.

Controller(s) 1136, which may include one or more system on chips (SoCs) 1104 (FIG. 11C) and/or GPU(s), may provide signals (e.g., representative of commands) to one or more components and/or systems of the vehicle 1100. For example, the controller(s) may send signals to operate the vehicle brakes via one or more brake actuators 1148, to operate the steering system 1154 via one or more steering actuators 1156, to operate the propulsion system 1150 via one or more throttle/accelerators 1152. The controller(s) 1136 may include one or more onboard (e.g., integrated) computing devices (e.g., supercomputers) that process sensor signals, and output operation commands (e.g., signals representing commands) to enable autonomous driving and/or to assist a human driver in driving the vehicle 1100. The controller(s) 1136 may include a first controller 1136 for autonomous driving functions, a second controller 1136 for functional safety functions, a third controller 1136 for artificial intelligence functionality (e.g., computer vision), a fourth controller 1136 for infotainment functionality, a fifth controller 1136 for redundancy in emergency conditions, and/or other controllers. In some examples, a single controller 1136 may handle two or more of the above functionalities, two or more controllers 1136 may handle a single functionality, and/or any combination thereof.

The controller(s) 1136 may provide the signals for controlling one or more components and/or systems of the vehicle 1100 in response to sensor data received from one or more sensors (e.g., sensor inputs). The sensor data may be received from, for example and without limitation, global navigation satellite systems (“GNSS”) sensor(s) 1158 (e.g., Global Positioning System sensor(s)), RADAR sensor(s) 1160, ultrasonic sensor(s) 1162, LIDAR sensor(s) 1164, inertial measurement unit (IMU) sensor(s) 1166 (e.g., accelerometer(s), gyroscope(s), magnetic compass(es), magnetometer(s), etc.), microphone(s) 1196, stereo camera(s) 1168, wide-view camera(s) 1170 (e.g., fisheye cameras), infrared camera(s) 1172, surround camera(s) 1174 (e.g., 360 degree cameras), long-range and/or mid-range camera(s) 1198, speed sensor(s) 1144 (e.g., for measuring the speed of the vehicle 1100), vibration sensor(s) 1142, steering sensor(s) 1140, brake sensor(s) (e.g., as part of the brake sensor system 1146), and/or other sensor types.

One or more of the controller(s) 1136 may receive inputs (e.g., represented by input data) from an instrument cluster 1132 of the vehicle 1100 and provide outputs (e.g., represented by output data, display data, etc.) via a human-machine interface (HMI) display 1134, an audible annunciator, a loudspeaker, and/or via other components of the vehicle 1100. The outputs may include information such as vehicle velocity, speed, time, map data (e.g., the High Definition (“HD”) map 1122 of FIG. 11C), location data (e.g., the vehicle's 1100 location, such as on a map), direction, location of other vehicles (e.g., an occupancy grid), information about objects and status of objects as perceived by the controller(s) 1136, etc. For example, the HMI display 1134 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1100 further includes a network interface 1124 which may use one or more wireless antenna(s) 1126 and/or modem(s) to communicate over one or more networks. For example, the network interface 1124 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1126 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 11B is an example of camera locations and fields of view for the example autonomous vehicle 1100 of FIG. 11A, in accordance with some embodiments of the present disclosure. The cameras and respective fields of view are one example embodiment and are not intended to be limiting. For example, additional and/or alternative cameras may be included and/or the cameras may be located at different locations on the vehicle 1100.

The camera types for the cameras may include, but are not limited to, digital cameras that may be adapted for use with the components and/or systems of the vehicle 1100. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1100 (e.g., front-facing cameras) may be used for surround view, to help identify forward facing paths and obstacles, as well aid in, with the help of one or more controllers 1136 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1170 that may be used to perceive objects coming into view from the periphery (e.g., pedestrians, crossing traffic or bicycles). Although only one wide-view camera is illustrated in FIG. 11B, there may be any number (including zero) of wide-view cameras 1170 on the vehicle 1100. In addition, any number of long-range camera(s) 1198 (e.g., a long-view stereo camera pair) may be used for depth-based object detection, especially for objects for which a neural network has not yet been trained. The long-range camera(s) 1198 may also be used for object detection and classification, as well as basic object tracking.

Any number of stereo cameras 1168 may also be included in a front-facing configuration. In at least one embodiment, one or more of stereo camera(s) 1168 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1168 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1168 may be used in addition to, or alternatively from, those described herein.

Cameras with a field of view that include portions of the environment to the side of the vehicle 1100 (e.g., side-view cameras) may be used for surround view, providing information used to create and update the occupancy grid, as well as to generate side impact collision warnings. For example, surround camera(s) 1174 (e.g., four surround cameras 1174 as illustrated in FIG. 11B) may be positioned to on the vehicle 1100. The surround camera(s) 1174 may include wide-view camera(s) 1170, fisheye camera(s), 360 degree camera(s), and/or the like. Four example, four fisheye cameras may be positioned on the vehicle's front, rear, and sides. In an alternative arrangement, the vehicle may use three surround camera(s) 1174 (e.g., left, right, and rear), and may leverage one or more other camera(s) (e.g., a forward-facing camera) as a fourth surround view camera.

Cameras with a field of view that include portions of the environment to the rear of the vehicle 1100 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1198, stereo camera(s) 1168), infrared camera(s) 1172, etc.), as described herein.

FIG. 11C is a block diagram of an example system architecture for the example autonomous vehicle 1100 of FIG. 11A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1100 in FIG. 11C are illustrated as being connected via bus 1102. The bus 1102 may include a Controller Area Network (CAN) data interface (alternatively referred to herein as a “CAN bus”). A CAN may be a network inside the vehicle 1100 used to aid in control of various features and functionality of the vehicle 1100, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1102 is described herein as being a CAN bus, this is not intended to be limiting. For example, in addition to, or alternatively from, the CAN bus, FlexRay and/or Ethernet may be used. Additionally, although a single line is used to represent the bus 1102, this is not intended to be limiting. For example, there may be any number of busses 1102, which may include one or more CAN busses, one or more FlexRay busses, one or more Ethernet busses, and/or one or more other types of busses using a different protocol. In some examples, two or more busses 1102 may be used to perform different functions, and/or may be used for redundancy. For example, a first bus 1102 may be used for collision avoidance functionality and a second bus 1102 may be used for actuation control. In any example, each bus 1102 may communicate with any of the components of the vehicle 1100, and two or more busses 1102 may communicate with the same components. In some examples, each SoC 1104, each controller 1136, and/or each computer within the vehicle may have access to the same input data (e.g., inputs from sensors of the vehicle 1100), and may be connected to a common bus, such the CAN bus.

The vehicle 1100 may include one or more controller(s) 1136, such as those described herein with respect to FIG. 11A. The controller(s) 1136 may be used for a variety of functions. The controller(s) 1136 may be coupled to any of the various other components and systems of the vehicle 1100, and may be used for control of the vehicle 1100, artificial intelligence of the vehicle 1100, infotainment for the vehicle 1100, and/or the like.

The vehicle 1100 may include a system(s) on a chip (SoC) 1104. The SoC 1104 may include CPU(s) 1106, GPU(s) 1108, processor(s) 1110, cache(s) 1112, accelerator(s) 1114, data store(s) 1116, and/or other components and features not illustrated. The SoC(s) 1104 may be used to control the vehicle 1100 in a variety of platforms and systems. For example, the SoC(s) 1104 may be combined in a system (e.g., the system of the vehicle 1100) with an HD map 1122 which may obtain map refreshes and/or updates via a network interface 1124 from one or more servers (e.g., server(s) 1178 of FIG. 11D).

The CPU(s) 1106 may include a CPU cluster or CPU complex (alternatively referred to herein as a “CCPLEX”). The CPU(s) 1106 may include multiple cores and/or L2 caches. For example, in some embodiments, the CPU(s) 1106 may include eight cores in a coherent multi-processor configuration. In some embodiments, the CPU(s) 1106 may include four dual-core clusters where each cluster has a dedicated L2 cache (e.g., a 2 MB L2 cache). The CPU(s) 1106 (e.g., the CCPLEX) may be configured to support simultaneous cluster operation enabling any combination of the clusters of the CPU(s) 1106 to be active at any given time.

The CPU(s) 1106 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1106 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1108 may include an integrated GPU (alternatively referred to herein as an “iGPU”). The GPU(s) 1108 may be programmable and may be efficient for parallel workloads. The GPU(s) 1108, in some examples, may use an enhanced tensor instruction set. The GPU(s) 1108 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1108 may include at least eight streaming microprocessors. The GPU(s) 1108 may use compute application programming interface(s) (API(s)). In addition, the GPU(s) 1108 may use one or more parallel computing platforms and/or programming models (e.g., NVIDIA's CUDA).

The GPU(s) 1108 may be power-optimized for best performance in automotive and embedded use cases. For example, the GPU(s) 1108 may be fabricated on a Fin field-effect transistor (FinFET). However, this is not intended to be limiting and the GPU(s) 1108 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1108 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1108 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1108 to access the CPU(s) 1106 page tables directly. In such examples, when the GPU(s) 1108 memory management unit (MMU) experiences a miss, an address translation request may be transmitted to the CPU(s) 1106. In response, the CPU(s) 1106 may look in its page tables for the virtual-to-physical mapping for the address and transmits the translation back to the GPU(s) 1108. As such, unified memory technology may allow a single unified virtual address space for memory of both the CPU(s) 1106 and the GPU(s) 1108, thereby simplifying the GPU(s) 1108 programming and porting of applications to the GPU(s) 1108.

In addition, the GPU(s) 1108 may include an access counter that may keep track of the frequency of access of the GPU(s) 1108 to memory of other processors. The access counter may help ensure that memory pages are moved to the physical memory of the processor that is accessing the pages most frequently.

The SoC(s) 1104 may include any number of cache(s) 1112, including those described herein. For example, the cache(s) 1112 may include an L3 cache that is available to both the CPU(s) 1106 and the GPU(s) 1108 (e.g., that is connected both the CPU(s) 1106 and the GPU(s) 1108). The cache(s) 1112 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1104 may include an arithmetic logic unit(s) (ALU(s)) which may be leveraged in performing processing with respect to any of the variety of tasks or operations of the vehicle 1100—such as processing DNNs. In addition, the SoC(s) 1104 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1106 and/or GPU(s) 1108.

The SoC(s) 1104 may include one or more accelerators 1114 (e.g., hardware accelerators, software accelerators, or a combination thereof). For example, the SoC(s) 1104 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1108 and to off-load some of the tasks of the GPU(s) 1108 (e.g., to free up more cycles of the GPU(s) 1108 for performing other tasks). As an example, the accelerator(s) 1114 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1114 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1108, and by using an inference accelerator, for example, a designer may target either the DLA(s) or the GPU(s) 1108 for any function. For example, the designer may focus processing of CNNs and floating point operations on the DLA(s) and leave other functions to the GPU(s) 1108 and/or other accelerator(s) 1114.

The accelerator(s) 1114 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1106. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1114 (e.g., the hardware acceleration cluster) may include a computer vision network on-chip and SRAM, for providing a high-bandwidth, low latency SRAM for the accelerator(s) 1114. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1104 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1114 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1166 output that correlates with the vehicle 1100 orientation, distance, 3D location estimates of the object obtained from the neural network and/or other sensors (e.g., LIDAR sensor(s) 1164 or RADAR sensor(s) 1160), among others.

The SoC(s) 1104 may include data store(s) 1116 (e.g., memory). The data store(s) 1116 may be on-chip memory of the SoC(s) 1104, which may store neural networks to be executed on the GPU and/or the DLA. In some examples, the data store(s) 1116 may be large enough in capacity to store multiple instances of neural networks for redundancy and safety. The data store(s) 1112 may comprise L2 or L3 cache(s) 1112. Reference to the data store(s) 1116 may include reference to the memory associated with the PVA, DLA, and/or other accelerator(s) 1114, as described herein.

The SoC(s) 1104 may include one or more processor(s) 1110 (e.g., embedded processors). The processor(s) 1110 may include a boot and power management processor that may be a dedicated processor and subsystem to handle boot power and management functions and related security enforcement. The boot and power management processor may be a part of the SoC(s) 1104 boot sequence and may provide runtime power management services. The boot power and management processor may provide clock and voltage programming, assistance in system low power state transitions, management of SoC(s) 1104 thermals and temperature sensors, and/or management of the SoC(s) 1104 power states. Each temperature sensor may be implemented as a ring-oscillator whose output frequency is proportional to temperature, and the SoC(s) 1104 may use the ring-oscillators to detect temperatures of the CPU(s) 1106, GPU(s) 1108, and/or accelerator(s) 1114. If temperatures are determined to exceed a threshold, the boot and power management processor may enter a temperature fault routine and put the SoC(s) 1104 into a lower power state and/or put the vehicle 1100 into a chauffeur to safe stop mode (e.g., bring the vehicle 1100 to a safe stop).

The processor(s) 1110 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1110 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1110 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1110 may further include a real-time camera engine that may include a dedicated processor subsystem for handling real-time camera management.

The processor(s) 1110 may further include a high-dynamic range signal processor that may include an image signal processor that is a hardware engine that is part of the camera processing pipeline.

The processor(s) 1110 may include a video image compositor that may be a processing block (e.g., implemented on a microprocessor) that implements video post-processing functions needed by a video playback application to produce the final image for the player window. The video image compositor may perform lens distortion correction on wide-view camera(s) 1170, surround camera(s) 1174, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1108 is not required to continuously render new surfaces. Even when the GPU(s) 1108 is powered on and active doing 3D rendering, the video image compositor may be used to offload the GPU(s) 1108 to improve performance and responsiveness.

The SoC(s) 1104 may further include a mobile industry processor interface (MIPI) camera serial interface for receiving video and input from cameras, a high-speed interface, and/or a video input block that may be used for camera and related pixel input functions. The SoC(s) 1104 may further include an input/output controller(s) that may be controlled by software and may be used for receiving I/O signals that are uncommitted to a specific role.

The SoC(s) 1104 may further include a broad range of peripheral interfaces to enable communication with peripherals, audio codecs, power management, and/or other devices. The SoC(s) 1104 may be used to process data from cameras (e.g., connected over Gigabit Multimedia Serial Link and Ethernet), sensors (e.g., LIDAR sensor(s) 1164, RADAR sensor(s) 1160, etc. that may be connected over Ethernet), data from bus 1102 (e.g., speed of vehicle 1100, steering wheel position, etc.), data from GNSS sensor(s) 1158 (e.g., connected over Ethernet or CAN bus). The SoC(s) 1104 may further include dedicated high-performance mass storage controllers that may include their own DMA engines, and that may be used to free the CPU(s) 1106 from routine data management tasks.

The SoC(s) 1104 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1104 may be faster, more reliable, and even more energy-efficient and space-efficient than conventional systems. For example, the accelerator(s) 1114, when combined with the CPU(s) 1106, the GPU(s) 1108, and the data store(s) 1116, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1120) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1108.

In some examples, a CNN for facial recognition and vehicle owner identification may use data from camera sensors to identify the presence of an authorized driver and/or owner of the vehicle 1100. The always on sensor processing engine may be used to unlock the vehicle when the owner approaches the driver door and turn on the lights, and, in security mode, to disable the vehicle when the owner leaves the vehicle. In this way, the SoC(s) 1104 provide for security against theft and/or carjacking.

In another example, a CNN for emergency vehicle detection and identification may use data from microphones 1196 to detect and identify emergency vehicle sirens. In contrast to conventional systems, that use general classifiers to detect sirens and manually extract features, the SoC(s) 1104 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1158. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1162, until the emergency vehicle(s) passes.

The vehicle may include a CPU(s) 1118 (e.g., discrete CPU(s), or dCPU(s)), that may be coupled to the SoC(s) 1104 via a high-speed interconnect (e.g., PCIe). The CPU(s) 1118 may include an X86 processor, for example. The CPU(s) 1118 may be used to perform any of a variety of functions, including arbitrating potentially inconsistent results between ADAS sensors and the SoC(s) 1104, and/or monitoring the status and health of the controller(s) 1136 and/or infotainment SoC 1130, for example.

The vehicle 1100 may include a GPU(s) 1120 (e.g., discrete GPU(s), or dGPU(s)), that may be coupled to the SoC(s) 1104 via a high-speed interconnect (e.g., NVIDIA's NVLINK). The GPU(s) 1120 may provide additional artificial intelligence functionality, such as by executing redundant and/or different neural networks, and may be used to train and/or update neural networks based on input (e.g., sensor data) from sensors of the vehicle 1100.

The vehicle 1100 may further include the network interface 1124 which may include one or more wireless antennas 1126 (e.g., one or more wireless antennas for different communication protocols, such as a cellular antenna, a Bluetooth antenna, etc.). The network interface 1124 may be used to enable wireless connectivity over the Internet with the cloud (e.g., with the server(s) 1178 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1100 information about vehicles in proximity to the vehicle 1100 (e.g., vehicles in front of, on the side of, and/or behind the vehicle 1100). This functionality may be part of a cooperative adaptive cruise control functionality of the vehicle 1100.

The network interface 1124 may include a SoC that provides modulation and demodulation functionality and enables the controller(s) 1136 to communicate over wireless networks. The network interface 1124 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1100 may further include data store(s) 1128 which may include off-chip (e.g., off the SoC(s) 1104) storage. The data store(s) 1128 may include one or more storage elements including RAM, SRAM, DRAM, VRAM, Flash, hard disks, and/or other components and/or devices that may store at least one bit of data.

The vehicle 1100 may further include GNSS sensor(s) 1158. The GNSS sensor(s) 1158 (e.g., GPS, assisted GPS sensors, differential GPS (DGPS) sensors, etc.), to assist in mapping, perception, occupancy grid generation, and/or path planning functions. Any number of GNSS sensor(s) 1158 may be used, including, for example and without limitation, a GPS using a USB connector with an Ethernet to Serial (RS-232) bridge.

The vehicle 1100 may further include RADAR sensor(s) 1160. The RADAR sensor(s) 1160 may be used by the vehicle 1100 for long-range vehicle detection, even in darkness and/or severe weather conditions. RADAR functional safety levels may be ASIL B. The RADAR sensor(s) 1160 may use the CAN and/or the bus 1102 (e.g., to transmit data generated by the RADAR sensor(s) 1160) for control and to access object tracking data, with access to Ethernet to access raw data in some examples. A wide variety of RADAR sensor types may be used. For example, and without limitation, the RADAR sensor(s) 1160 may be suitable for front, rear, and side RADAR use. In some example, Pulse Doppler RADAR sensor(s) are used.

The RADAR sensor(s) 1160 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1160 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1100 surroundings at higher speeds with minimal interference from traffic in adjacent lanes. The other two antennae may expand the field of view, making it possible to quickly detect vehicles entering or leaving the vehicle's 1100 lane.

Mid-range RADAR systems may include, as an example, a range of up to 1160 m (front) or 80 m (rear), and a field of view of up to 42 degrees (front) or 1150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1100 may further include ultrasonic sensor(s) 1162. The ultrasonic sensor(s) 1162, which may be positioned at the front, back, and/or the sides of the vehicle 1100, may be used for park assist and/or to create and update an occupancy grid. A wide variety of ultrasonic sensor(s) 1162 may be used, and different ultrasonic sensor(s) 1162 may be used for different ranges of detection (e.g., 2.5 m, 4 m). The ultrasonic sensor(s) 1162 may operate at functional safety levels of ASIL B.

The vehicle 1100 may include LIDAR sensor(s) 1164. The LIDAR sensor(s) 1164 may be used for object and pedestrian detection, emergency braking, collision avoidance, and/or other functions. The LIDAR sensor(s) 1164 may be functional safety level ASIL B. In some examples, the vehicle 1100 may include multiple LIDAR sensors 1164 (e.g., two, four, six, etc.) that may use Ethernet (e.g., to provide data to a Gigabit Ethernet switch).

In some examples, the LIDAR sensor(s) 1164 may be capable of providing a list of objects and their distances for a 360-degree field of view. Commercially available LIDAR sensor(s) 1164 may have an advertised range of approximately 1100 m, with an accuracy of 2 cm-3 cm, and with support for a 1100 Mbps Ethernet connection, for example. In some examples, one or more non-protruding LIDAR sensors 1164 may be used. In such examples, the LIDAR sensor(s) 1164 may be implemented as a small device that may be embedded into the front, rear, sides, and/or corners of the vehicle 1100. The LIDAR sensor(s) 1164, in such examples, may provide up to a 120-degree horizontal and 35-degree vertical field-of-view, with a 200 m range even for low-reflectivity objects. Front-mounted LIDAR sensor(s) 1164 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1100. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1164 may be less susceptible to motion blur, vibration, and/or shock.

The vehicle may further include IMU sensor(s) 1166. The IMU sensor(s) 1166 may be located at a center of the rear axle of the vehicle 1100, in some examples. The IMU sensor(s) 1166 may include, for example and without limitation, an accelerometer(s), a magnetometer(s), a gyroscope(s), a magnetic compass(es), and/or other sensor types. In some examples, such as in six-axis applications, the IMU sensor(s) 1166 may include accelerometers and gyroscopes, while in nine-axis applications, the IMU sensor(s) 1166 may include accelerometers, gyroscopes, and magnetometers.

In some embodiments, the IMU sensor(s) 1166 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1166 may enable the vehicle 1100 to estimate heading without requiring input from a magnetic sensor by directly observing and correlating the changes in velocity from GPS to the IMU sensor(s) 1166. In some examples, the IMU sensor(s) 1166 and the GNSS sensor(s) 1158 may be combined in a single integrated unit.

The vehicle may include microphone(s) 1196 placed in and/or around the vehicle 1100. The microphone(s) 1196 may be used for emergency vehicle detection and identification, among other things.

The vehicle may further include any number of camera types, including stereo camera(s) 1168, wide-view camera(s) 1170, infrared camera(s) 1172, surround camera(s) 1174, long-range and/or mid-range camera(s) 1198, and/or other camera types. The cameras may be used to capture image data around an entire periphery of the vehicle 1100. The types of cameras used depends on the embodiments and requirements for the vehicle 1100, and any combination of camera types may be used to provide the necessary coverage around the vehicle 1100. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 11A and FIG. 11B.

The vehicle 1100 may further include vibration sensor(s) 1142. The vibration sensor(s) 1142 may measure vibrations of components of the vehicle, such as the axle(s). For example, changes in vibrations may indicate a change in road surfaces. In another example, when two or more vibration sensors 1142 are used, the differences between the vibrations may be used to determine friction or slippage of the road surface (e.g., when the difference in vibration is between a power-driven axle and a freely rotating axle).

The vehicle 1100 may include an ADAS system 1138. The ADAS system 1138 may include a SoC, in some examples. The ADAS system 1138 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1160, LIDAR sensor(s) 1164, and/or a camera(s). The ACC systems may include longitudinal ACC and/or lateral ACC. Longitudinal ACC monitors and controls the distance to the vehicle immediately ahead of the vehicle 1100 and automatically adjust the vehicle speed to maintain a safe distance from vehicles ahead. Lateral ACC performs distance keeping, and advises the vehicle 1100 to change lanes when necessary. Lateral ACC is related to other ADAS applications such as LCA and CWS.

CACC uses information from other vehicles that may be received via the network interface 1124 and/or the wireless antenna(s) 1126 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 1100), while the 12V communication concept provides information about traffic further ahead. CACC systems may include either or both I2V and V2V information sources. Given the information of the vehicles ahead of the vehicle 1100, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1160, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1160, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1100 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1100 if the vehicle 1100 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1160, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1100 is backing up. Some RCTW systems include AEB to ensure that the vehicle brakes are applied to avoid a crash. RCTW systems may use one or more rear-facing RADAR sensor(s) 1160, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1100, the vehicle 1100 itself must, in the case of conflicting results, decide whether to heed the result from a primary computer or a secondary computer (e.g., a first controller 1136 or a second controller 1136). For example, in some embodiments, the ADAS system 1138 may be a backup and/or secondary computer for providing perception information to a backup computer rationality module. The backup computer rationality monitor may run a redundant diverse software on hardware components to detect faults in perception and dynamic driving tasks. Outputs from the ADAS system 1138 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1104.

In other examples, ADAS system 1138 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1138 may be fed into the primary computer's perception block and/or the primary computer's dynamic driving task block. For example, if the ADAS system 1138 indicates a forward crash warning due to an object immediately ahead, the perception block may use this information when identifying objects. In other examples, the secondary computer may have its own neural network which is trained and thus reduces the risk of false positives, as described herein.

The vehicle 1100 may further include the infotainment SoC 1130 (e.g., an in-vehicle infotainment system (IVI)). Although illustrated and described as a SoC, the infotainment system may not be a SoC, and may include two or more discrete components. The infotainment SoC 1130 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1100. For example, the infotainment SoC 1130 may radios, disk players, navigation systems, video players, USB and Bluetooth connectivity, carputers, in-car entertainment, Wi-Fi, steering wheel audio controls, hands free voice control, a heads-up display (HUD), an HMI display 1134, a telematics device, a control panel (e.g., for controlling and/or interacting with various components, features, and/or systems), and/or other components. The infotainment SoC 1130 may further be used to provide information (e.g., visual and/or audible) to a user(s) of the vehicle, such as information from the ADAS system 1138, autonomous driving information such as planned vehicle maneuvers, trajectories, surrounding environment information (e.g., intersection information, vehicle information, road information, etc.), and/or other information.

The infotainment SoC 1130 may include GPU functionality. The infotainment SoC 1130 may communicate over the bus 1102 (e.g., CAN bus, Ethernet, etc.) with other devices, systems, and/or components of the vehicle 1100. In some examples, the infotainment SoC 1130 may be coupled to a supervisory MCU such that the GPU of the infotainment system may perform some self-driving functions in the event that the primary controller(s) 1136 (e.g., the primary and/or backup computers of the vehicle 1100) fail. In such an example, the infotainment SoC 1130 may put the vehicle 1100 into a chauffeur to safe stop mode, as described herein.

The vehicle 1100 may further include an instrument cluster 1132 (e.g., a digital dash, an electronic instrument cluster, a digital instrument panel, etc.). The instrument cluster 1132 may include a controller and/or supercomputer (e.g., a discrete controller or supercomputer). The instrument cluster 1132 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1130 and the instrument cluster 1132. In other words, the instrument cluster 1132 may be included as part of the infotainment SoC 1130, or vice versa.

FIG. 11D is a system diagram for communication between cloud-based server(s) and the example autonomous vehicle 1100 of FIG. 11A, in accordance with some embodiments of the present disclosure. The system 1176 may include server(s) 1178, network(s) 1190, and vehicles, including the vehicle 1100. The server(s) 1178 may include a plurality of GPUs 1184(A)-1184 (H) (collectively referred to herein as GPUs 1184), PCIe switches 1182(A)-1182(H) (collectively referred to herein as PCIe switches 1182), and/or CPUs 1180(A)-1180(B) (collectively referred to herein as CPUs 1180). The GPUs 1184, the CPUs 1180, and the PCIe switches may be interconnected with high-speed interconnects such as, for example and without limitation, NVLink interfaces 1188 developed by NVIDIA and/or PCIe connections 1186. In some examples, the GPUs 1184 are connected via NVLink and/or NVSwitch SoC and the GPUs 1184 and the PCIe switches 1182 are connected via PCIe interconnects. Although eight GPUs 1184, two CPUs 1180, and two PCIe switches are illustrated, this is not intended to be limiting. Depending on the embodiment, each of the server(s) 1178 may include any number of GPUs 1184, CPUs 1180, and/or PCIe switches. For example, the server(s) 1178 may each include eight, sixteen, thirty-two, and/or more GPUs 1184.

The server(s) 1178 may receive, over the network(s) 1190 and from the vehicles, image data representative of images showing unexpected or changed road conditions, such as recently commenced road-work. The server(s) 1178 may transmit, over the network(s) 1190 and to the vehicles, neural networks 1192, updated neural networks 1192, and/or map information 1194, including information regarding traffic and road conditions. The updates to the map information 1194 may include updates for the HD map 1122, such as information regarding construction sites, potholes, detours, flooding, and/or other obstructions. In some examples, the neural networks 1192, the updated neural networks 1192, and/or the map information 1194 may have resulted from new training and/or experiences represented in data received from any number of vehicles in the environment, and/or based on training performed at a datacenter (e.g., using the server(s) 1178 and/or other servers).

The server(s) 1178 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1190, and/or the machine learning models may be used by the server(s) 1178 to remotely monitor the vehicles.

In some examples, the server(s) 1178 may receive data from the vehicles and apply the data to up-to-date real-time neural networks for real-time intelligent inferencing. The server(s) 1178 may include deep-learning supercomputers and/or dedicated AI computers powered by GPU(s) 1184, such as a DGX and DGX Station machines developed by NVIDIA. However, in some examples, the server(s) 1178 may include deep learning infrastructure that use only CPU-powered datacenters.

The deep-learning infrastructure of the server(s) 1178 may be capable of fast, real-time inferencing, and may use that capability to evaluate and verify the health of the processors, software, and/or associated hardware in the vehicle 1100. For example, the deep-learning infrastructure may receive periodic updates from the vehicle 1100, such as a sequence of images and/or objects that the vehicle 1100 has located in that sequence of images (e.g., via computer vision and/or other machine learning object classification techniques). The deep-learning infrastructure may run its own neural network to identify the objects and compare them with the objects identified by the vehicle 1100 and, if the results do not match and the infrastructure concludes that the AI in the vehicle 1100 is malfunctioning, the server(s) 1178 may transmit a signal to the vehicle 1100 instructing a fail-safe computer of the vehicle 1100 to assume control, notify the passengers, and complete a safe parking maneuver.

For inferencing, the server(s) 1178 may include the GPU(s) 1184 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161 (N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1333, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1333 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1333. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316 (N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Language Models

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs-such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pretraining on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. No. 18,304,341, filed on Apr. 20, 2023, the contents of which are hereby incorporated by reference in their entirety. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

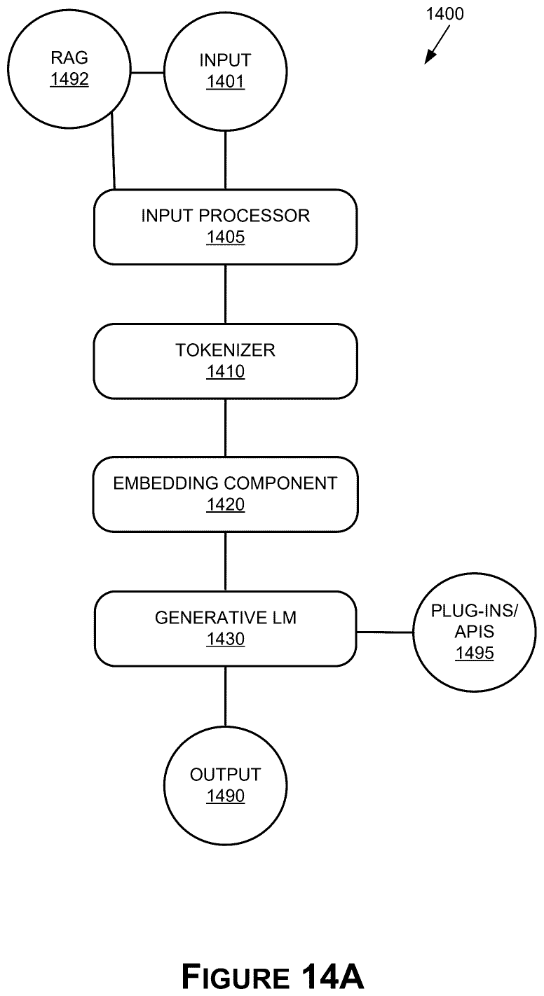

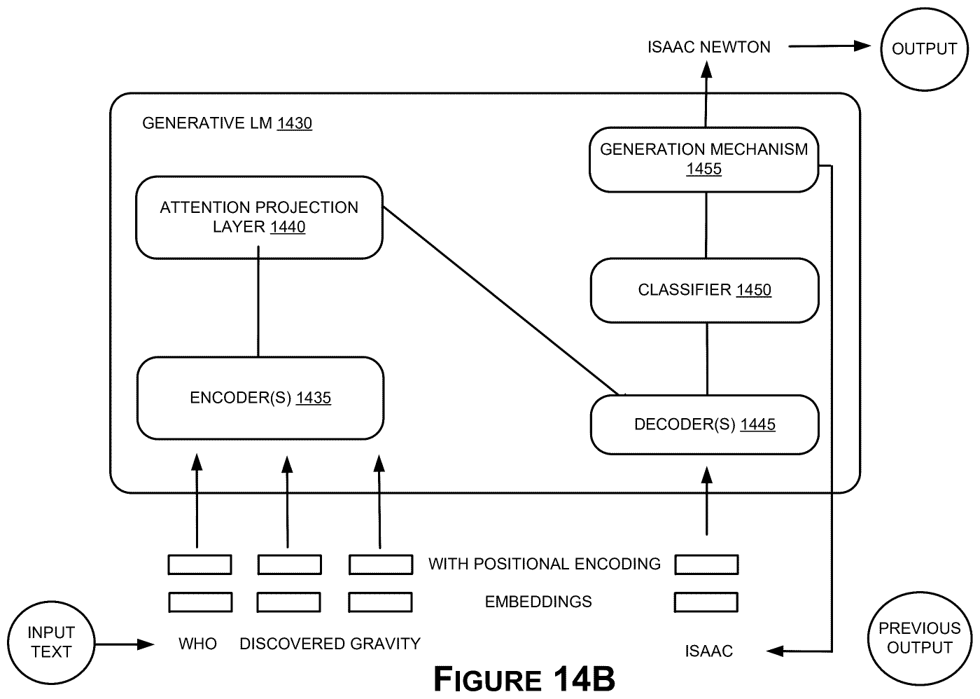

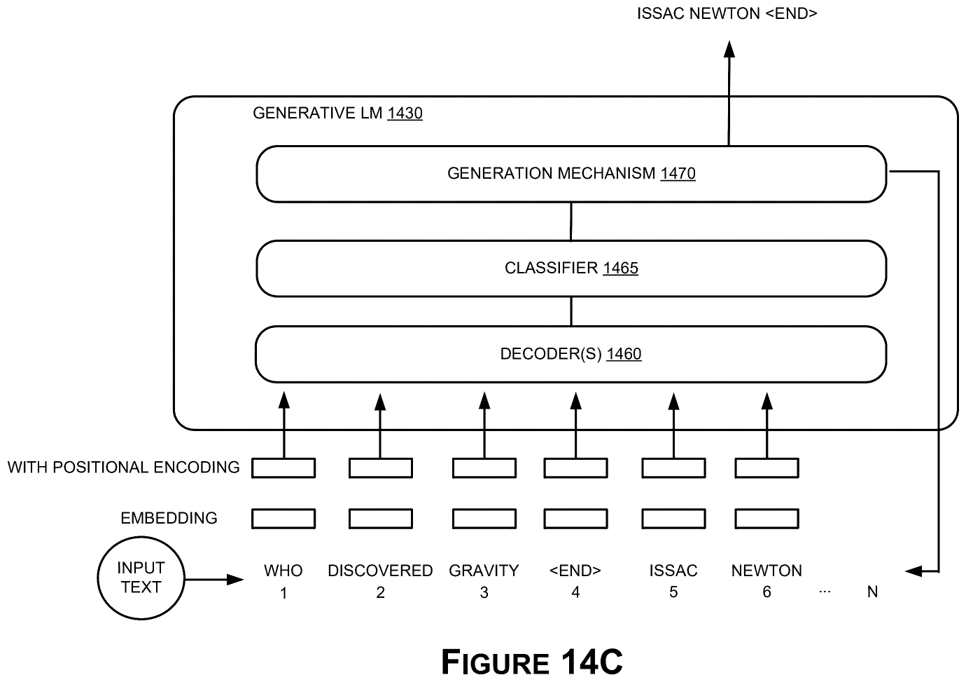

FIG. 14A is a block diagram of an example generative language model system 1400 suitable for use in implementing at least some embodiments of the present disclosure. In the example illustrated in FIG. 14A, the generative language model system 1400 includes a retrieval augmented generation (RAG) component 1492, an input processor 1405, a tokenizer 1410, an embedding component 1420, plug-ins/APIs 1495, and a generative language model (LM) 1430 (which may include an LLM, a VLM, a multi-modal LM, etc.).

At a high level, the input processor 1405 may receive an input 1401 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 1430. In some embodiments, the input 1401 includes plain text in the form of one or more sentences, paragraphs, and/or documents. Additionally or alternatively, the input 1401 may include numerical sequences, precomputed embeddings (e.g., word or sentence embeddings), and/or structured data (e.g., in tabular formats, JSON, or XML). In some implementations in which the generative LM 1430 is capable of processing multimodal inputs, the input 1401 may combine text with image data, audio data, and/or other types of input data, such as but not limited to those described herein. Taking raw input text as an example, the input processor 1405 may prepare raw input text in various ways. For example, the input processor 1405 may perform various types of text cleaning to remove noise (e.g., special characters, punctuation, HTML tags, stopwords) from relevant textual content. In an example involving stopwords (common words that tend to carry little semantic meaning), the input processor 1405 may remove stopwords to reduce noise and focus the generative LM 1430 on more meaningful content. The input processor 1405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1492 may be used to retrieve additional information to be used as part of the input 1401 or prompt. For example, in some embodiments, the input 1401 may be generated using the query or input to the model (e.g., a question, a request, etc.) in addition to data retrieved using the RAG component 1492. In some embodiments, the input processor 1405 may analyze the input 1401 and communicate with the RAG component 1492 (or the RAG component 1492 may be part of the input processor 1405, in embodiments) in order to identify relevant text and/or other data to provide to the generative LM 1430 as additional context or sources of information from which to identify the response, answer, or output 1490, generally. For example, where the input indicates that the user is interested in a desired tire pressure for a particular make and model of vehicle, the RAG component 1492 may retrieve-using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1492 may retrieve a prior stored conversation history—or at least a summary thereof—and include the prior conversation history along with the current ask/request as part of the input 1401 to the generative LM 1430.

The tokenizer 1410 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 1430 to understand morphological variations and handle out-of-vocabulary words more effectively. Character-based tokenization represents each character as a separate token, enabling the generative LM 1430 to process text at a fine-grained level. The choice of tokenization strategy may depend on factors such as the language being processed, the task at hand, and/or characteristics of the training dataset. As such, the tokenizer 1410 may convert the (e.g., processed) text into a structured format according to tokenization schema being implemented in the particular embodiment.

The embedding component 1420 may use any known embedding technique to transform discrete tokens into (e.g., dense, continuous vector) representations of semantic meaning. For example, the embedding component 1420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1401 includes image data, the input processor 1401 may resize the image data to a standard size compatible with format of a corresponding input channel and/or may normalize pixel values to a common range (e.g., 0 to 1) to ensure a consistent representation, and the embedding component 1420 may encode the image data using any known technique (e.g., using one or more convolutional neural networks (CNNs) to extract visual features). In some implementations in which the input 1401 includes audio data, the input processor 1401 may resample an audio file to a consistent sampling rate for uniform processing, and the embedding component 1420 may use any known technique to extract and encode audio features-such as in the form of a spectrogram (e.g., a mel-spectrogram). In some implementations in which the input 1401 includes video data, the input processor 1401 may extract frames or apply resizing to extracted frames, and the embedding component 1420 may extract features such as optical flow embeddings or video embeddings and/or may encode temporal information or sequences of frames. In some implementations in which the input 1401 includes multimodal data, the embedding component 1420 may fuse representations of the different types of data (e.g., text, image, audio) using techniques like early fusion (concatenation), late fusion (sequential processing), attention-based fusion, etc.

The generative LM 1430 and/or other components of the generative LLM system 1400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1420 may apply an encoded representation of the input 1401 to the generative LM 1430, and the generative LM 1430 may process the encoded representation of the input 1401 to generate an output 1490, which may include responsive text and/or other types of data.

As described herein, in some embodiments, the generative LM 1430 may be configured to access or use—or capable of accessing or using-plug-ins/APIs 1495 (which may include one or more plug-ins, application programming interfaces (APIs), databases, data stores, repositories, etc.). For example, for certain tasks or operations that the generative LM 1430 is not ideally suited for, the model may have instructions (e.g., as a result of training, and/or based on instructions in a given prompt, such as those retrieved using the RAG component 1492) to access one or more plug-ins/APIs 1495 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1495 to the plug-in/API 1495, the plug-in/API 1495 may process the information and return an answer to the generative LM 1430, and the generative LM 1430 may use the response to generate the output 1490. This process may be repeated—e.g., recursively—for any number of iterations and using any number of plug-ins/APIs 1495 until an output 1490 that addresses each ask/question/request/process/operation/etc from the input 1401 can be generated. As such, the model(s) may not only rely on its own knowledge from training on a large dataset(s) and/or from data retrieved using the RAG component 1492, but also on the expertise or optimized nature of one or more external resources—such as the plug-ins/APIs 1495.

FIG. 14B is a block diagram of an example implementation in which the generative LM 1430 includes a transformer encoder-decoder. For example, assume input text such as “Who discovered gravity” is tokenized (e.g., by the tokenizer 1410 of FIG. 14A) into tokens such as words, and each token is encoded (e.g., by the embedding component 1420 of FIG. 914A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1435 of the generative LM 1430.

In an example implementation, the encoder(s) 1435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1440 may convert the context vector into attention vectors (keys and values) for the decoder(s) 1445.

In an example implementation, the decoder(s) 1445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1435, in an example transformer architecture, each token (e.g., word) flows through a separate path in the decoder(s) 1445. During a first pass, the decoder(s) 1445, a classifier 1450, and a generation mechanism 1455 may generate a first token, and the generation mechanism 1455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1435, except that it creates its queries from the layer below it and takes the keys and values (e.g., matrix) from the output of the encoder(s) 1435.

As such, the decoder(s) 1445 may output some decoded (e.g., vector) representation of the input being applied during a particular pass. The classifier 1450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1455 may select or sample a word or token based on a corresponding predicted probability (e.g., select the word with the highest predicted probability) and append it to the output from a previous pass, generating each word or token sequentially. The generation mechanism 1455 may repeat the process, triggering successive decoder inputs and corresponding predictions until selecting or sampling a symbol or token that represents the end of the response, at which point, the generation mechanism 1455 may output the generated response.

FIG. 14C is a block diagram of an example implementation in which the generative LM 1430 includes a decoder-only transformer architecture. For example, the decoder(s) 1460 of FIG. 14C may operate similarly as the decoder(s) 1445 of FIG. 14B except each of the decoder(s) 1460 of FIG. 14C omits the encoder-decoder self-attention layer (since there is no encoder in this implementation). As such, the decoder(s) 1460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1460. As with the decoder(s) 1445 of FIG. 14B, each token (e.g., word) may flow through a separate path in the decoder(s) 1460, and the decoder(s) 1460, a classifier 1465, and a generation mechanism 1470 may use auto-regression to sequentially generate one token at a time until predicting a symbol or token that represents the end of the response. The classifier 1465 and the generation mechanism 1470 may operate similarly as the classifier 1450 and the generation mechanism 1455 of FIG. 14B, with the generation mechanism 1470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Paragraphs

A: A method comprising: generating, using one or more multi-modal language models, one or more embeddings associated with one or more portions of one or more images; determining, based at least on a query, at least an embedding of the one or more embeddings that is associated with a portion of the one or more portions; determining, based at least on the embedding, that an image of the one or more images is associated with the query; and sending, to a client device associated with the query, at least one of image data representative of the image or data indicating a location of the portion within the image.

B: The method of paragraph A, wherein: the query indicates positional information associated with at least one of an object or a feature; and the determining the image is associated with the query comprises: determining, based at least on location data associated with the embedding, that the portion of the image is associated with the location within the image; determining that the location corresponds to the positional information; and determining the image based at least on the location corresponding to the positional information.

C: The method of either paragraph A or paragraph B, further comprising: receiving, from the client device, a selection associated with the image; determining, based at least on the selection and using at least one of the embedding or a second embedding associated with the image, a third embedding of the one or more embeddings that is associated with a second portion of the one or more portions; determining, based at least on the second embedding, that a second image of the one or more images is associated with the query; and sending, to the client device, at least one of second image data representative of the second image or second data indicating a second location of the second portion within the second image.

D: The method of any one of paragraphs A-C, wherein the portion of the image is associated with a first object indicated by the query, and wherein the method further comprises: determining, based at least on a second object indicated by the query, at least a second embedding of the one or more embeddings that is associated with a second portion of the one or more portions; and determining, based at least on the second embedding, that the image of the one or more images is again associated with the query.

E: The method of paragraph D, wherein the query further indicates positional information associated with the first object and the second object, and wherein the method further comprises: determining that the portion is at the location within the image; determining that the second portion is at a second location within the image; determining, based at least on the location and the second location, that the image represents the first object at a direction with respect to the second object; and determining that the direction is associated with the positional information, wherein the sending the image data is further based at least on the direction being associated with the positional information.

F: The method of any one of paragraphs A-E, further comprising: segmenting the one or more images into the one or more portions; determining one or more locations associated with the one or more portions within the one or more images; determining one or more identifiers that associate the one or more portions with the one or more images; and storing, in one or more databases, the one or more embeddings, second data representative of the one or more locations, and third data representative of the one or more identifiers.

G: The method of any one of paragraphs A-F, further comprising: determining a second embedding based at least on at least one of an image, text, or an inputted embedding from the query, wherein the determining the at least the embedding from the one or more embeddings is based at least on the second embedding.

H: A system comprising: one or more processors to: store one or more embeddings associated with one or more portions of one or more images; determine, based at least on the one or more embeddings, at least a portion of the one or more portions that is associated with a query, the portion being associated with an image of the one or more images; and provide at least one of image data representative of the image or data indicating a location of the portion within the image.

I: The system of paragraph H, wherein: the query indicates positional information associated with at least one of an object or a feature; and the one or more processors are further to determine that the location of the portion within the image is associated with the positional information; and the at least one of the image data or the data indicating the location is further provided based at least on the location of the portion within the image being associated with the positional information.

J: The system of paragraph I, wherein the one or more processors are further to: store second data representing one or more locations associated with the one or more portions within the one or more images, wherein the determination that the location of the portion within the image is associated with the positional information is based at least on the second data.

K: The system of any one of paragraphs H-J, wherein the one or more processors are further to: receive input data representing a selection associated with the image; determine, based at least on the one or more embeddings, at least a second portion of the one or more portions that that is associated with the image, the second portion being associated with a second image of the one or more images; and provide at least one of second image data representative of the second image or second data indicating a second location of the second portion within the second image.

L: The system of paragraph K, wherein the one or more processors are further to: generate a second query using at least one of a first embedding associated with the query, a second embedding associated with the portion, or a third embedding associated with the image, wherein the determination of the at least the second portion of the one or more portions is further based at least on the second query.

M: The system of any one of paragraphs H-L, wherein the portion of the image is associated with a first object indicated by the query, and wherein the one or more processors are further to: determine, based at least on the one or more embeddings, at least a second portion of the one or more portions that is associated with a second object indicated by the query, the second portion also being associated with the image of the one or more images, wherein the image data is further provided based at least on the determination of the second portion.

N: The system of paragraph M, wherein the query further indicates positional information associated with the first object and the second object, and wherein the one or more processors are further to: determine that the portion is at the location within the image; determine that the second portion is at a second location within the image; determine, based at least on the location and the second location, that the image represents the first object at a direction with respect to the second object; and determine that the direction is associated with the positional information, wherein the image data is further provided based at least on the direction being associated with the positional information.

O: The system of any one of paragraphs H-N, wherein the one or more processors are further to: segment the one or more images into the one or more portions; determine one or more locations associated with the one or more portions within the one or more images; determine one or more identifiers that associate the one or more portions with the one or more images; and store, in association with the one or more embeddings, second data representative of the one or more locations and third data representative of the one or more identifiers.

P: The system of any one of paragraphs H-O, wherein the one or more processors are further to: determine a second embedding based at least on at least one of an image, text, or an inputted embedding from the query, wherein the determination the at least the portion of the one or more portions that is associated with the query is further based at least on the second embedding.

Q: The system of any one of paragraphs H-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

R: One or more processors comprising: processing circuitry to: determine, based at least on one or more embeddings associated with one or more portions of one or more images, that the one or more images are associated with positional information indicated by a query; and providing, to a client device, image data representative of the one or more images.

S: The one or more processors of paragraph R, wherein: the positional information indicates one or more first locations associated with one or more objects indicated by the query; and the determination that the one or more images are associated with the positional information indicated by the query comprises: determining, based at least on the one or more embeddings, that the one or more portions represent the one or more objects; determining that the one or more portions are at one or more second locations within the one or more images; determining that the one or more second locations correspond to the one or more first locations; and determining the one or more images based at least on the one or more second locations corresponding to the one or more first locations.

T: The one or more processors of either paragraph R or paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
generating, using one or more multi-modal language models, one or more embeddings associated with one or more portions of one or more images;
determining, based at least on a query, at least an embedding of the one or more embeddings that is associated with a portion of the one or more portions;
determining, based at least on the embedding, that an image of the one or more images is associated with the query; and
sending, to a client device associated with the query, at least one of image data representative of the image or data indicating a location of the portion within the image.

2. The method of claim 1, wherein:
the query indicates positional information associated with at least one of an object or a feature; and
the determining the image is associated with the query comprises:
determining, based at least on location data associated with the embedding, that the portion of the image is associated with the location within the image;
determining that the location corresponds to the positional information; and
determining the image based at least on the location corresponding to the positional information.

3. The method of claim 1, further comprising:
receiving, from the client device, a selection associated with the image;
determining, based at least on the selection and using at least one of the embedding or a second embedding associated with the image, a third embedding of the one or more embeddings that is associated with a second portion of the one or more portions;
determining, based at least on the second embedding, that a second image of the one or more images is associated with the query; and
sending, to the client device, at least one of second image data representative of the second image or second data indicating a second location of the second portion within the second image.

4. The method of claim 1, wherein the portion of the image is associated with a first object indicated by the query, and wherein the method further comprises:
determining, based at least on a second object indicated by the query, at least a second embedding of the one or more embeddings that is associated with a second portion of the one or more portions; and
determining, based at least on the second embedding, that the image of the one or more images is again associated with the query.

5. The method of claim 4, wherein the query further indicates positional information associated with the first object and the second object, and wherein the method further comprises:
determining that the portion is at the location within the image;
determining that the second portion is at a second location within the image;
determining, based at least on the location and the second location, that the image represents the first object at a direction with respect to the second object; and
determining that the direction is associated with the positional information, wherein the sending the image data is further based at least on the direction being associated with the positional information.

6. The method of claim 1, further comprising:
segmenting the one or more images into the one or more portions;
determining one or more locations associated with the one or more portions within the one or more images;
determining one or more identifiers that associate the one or more portions with the one or more images; and
storing, in one or more databases, the one or more embeddings, second data representative of the one or more locations, and third data representative of the one or more identifiers.

7. The method of claim 1, further comprising:
determining a second embedding based at least on at least one of an image, text, or an inputted embedding from the query,
wherein the determining the at least the embedding from the one or more embeddings is based at least on the second embedding.

8. A system comprising:
one or more processors to:
store one or more embeddings associated with one or more portions of one or more images;
determine, based at least on the one or more embeddings, at least a portion of the one or more portions that is associated with a query, the portion being associated with an image of the one or more images; and
provide at least one of image data representative of the image or data indicating a location of the portion within the image.

9. The system of claim 8, wherein:
the query indicates positional information associated with at least one of an object or a feature; and
the one or more processors are further to determine that the location of the portion within the image is associated with the positional information; and
the at least one of the image data or the data indicating the location is further provided based at least on the location of the portion within the image being associated with the positional information.

10. The system of claim 9, wherein the one or more processors are further to:
store second data representing one or more locations associated with the one or more portions within the one or more images,
wherein the determination that the location of the portion within the image is associated with the positional information is based at least on the second data.

11. The system of claim 8, wherein the one or more processors are further to:
receive input data representing a selection associated with the image;
determine, based at least on the one or more embeddings, at least a second portion of the one or more portions that that is associated with the image, the second portion being associated with a second image of the one or more images; and
provide at least one of second image data representative of the second image or second data indicating a second location of the second portion within the second image.

12. The system of claim 11, wherein the one or more processors are further to:
generate a second query using at least one of a first embedding associated with the query, a second embedding associated with the portion, or a third embedding associated with the image,
wherein the determination of the at least the second portion of the one or more portions is further based at least on the second query.

13. The system of claim 8, wherein the portion of the image is associated with a first object indicated by the query, and wherein the one or more processors are further to:
determine, based at least on the one or more embeddings, at least a second portion of the one or more portions that is associated with a second object indicated by the query, the second portion also being associated with the image of the one or more images,
wherein the image data is further provided based at least on the determination of the second portion.

14. The system of claim 13, wherein the query further indicates positional information associated with the first object and the second object, and wherein the one or more processors are further to:
determine that the portion is at the location within the image;
determine that the second portion is at a second location within the image;
determine, based at least on the location and the second location, that the image represents the first object at a direction with respect to the second object; and
determine that the direction is associated with the positional information,
wherein the image data is further provided based at least on the direction being associated with the positional information.

15. The system of claim 8, wherein the one or more processors are further to:
segment the one or more images into the one or more portions;
determine one or more locations associated with the one or more portions within the one or more images;
determine one or more identifiers that associate the one or more portions with the one or more images; and
store, in association with the one or more embeddings, second data representative of the one or more locations and third data representative of the one or more identifiers.

16. The system of claim 8, wherein the one or more processors are further to:
determine a second embedding based at least on at least one of an image, text, or an inputted embedding from the query,
wherein the determination the at least the portion of the one or more portions that is associated with the query is further based at least on the second embedding.

17. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. One or more processors comprising:
processing circuitry to:
determine, based at least on one or more embeddings associated with one or more portions of one or more images, that the one or more images are associated with positional information indicated by a query; and
providing, to a client device, image data representative of the one or more images.

19. The one or more processors of claim 18, wherein:
the positional information indicates one or more first locations associated with one or more objects indicated by the query; and
the determination that the one or more images are associated with the positional information indicated by the query comprises:
determining, based at least on the one or more embeddings, that the one or more portions represent the one or more objects;
determining that the one or more portions are at one or more second locations within the one or more images;
determining that the one or more second locations correspond to the one or more first locations; and
determining the one or more images based at least on the one or more second locations corresponding to the one or more first locations.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
